(19) United States
(12) Patent Application Publication
(10) Pub. No.: US 2025/0030686 A1
(43) Pub. Date: Jan. 23, 2025

(54) SYSTEMS AND METHODS FOR QUANTUM VERIFICATION OF COMMUNICATIONS

(71) Applicant: Wells Fargo Bank, N.A., San Francisco, CA (US)

(72) Inventors: Richard Toohey, Madison, WI (US); Jeff J. Stapleton, Irving, TX (US); Michael Erik Meinholz, Charlotte, NC (US); Peter Bordow, Fountain Hills, AZ (US); Ilber Gashi, Huntersville, NC (US)

(21) Appl. No.: 17/445,062

(22) Filed: Aug. 13, 2021

(51) Int. Cl. H04L 29/06; H04B 10/70; H04L 9/08

(52) U.S. Cl. CPC H04L 63/0876; H04B 10/70; H04L 9/0858; H04L 63/0435; H04L 2209/34

(57) ABSTRACT

Systems, apparatuses, methods, and computer program products are disclosed for authenticating devices. An example method includes generating pairs of entangled photons by a first device. One photon of each entangled photon pair may be transmitted to a second device. The first device and the second device may attempt to measure respective photons of the entangled photon pair to obtain a bit of a bit sequence. The bits may be encoded in the polarizations of the entangled photon pairs and may correspond to a true random number due to the generation method used by the first device. The second device may provide authentication data based on the bit sequence to the first device. The first device may use its copy of the bit sequence and the authentication data to authenticate the second device.

### BACKGROUND

Modern systems may facilitate communication between parties at various physical locations out of eyesight of one another. Such systems may be highly distributed with various components being located substantial distances from one another. The distances between these components and flaws in the operation of the components may allow for third parties to gain access to communications between parties over these systems.

### BRIEF SUMMARY

Communication systems facilitate a broad array of interactions between computer systems and users thereof. As part of these interactions, the computer systems may send and receive sensitive data. Due to the value of the sensitive data, third parties may attempt to modify sensitive data or masquerade as a legitimate party.

These third parties have adopted a range of methods of obtaining copies of sensitive data that exploit various weaknesses in communications systems. For example, the third parties may impersonate actors in the system to convince other actors (e.g., those authorized to send and access sensitive data) to send copies of sensitive data to the third parties. An another example, third parties may attempt to modify data-in-transit or data-at-rest.

Systems, apparatuses, methods, and computer program products are disclosed herein for authenticating devices and users thereof in a distributed system. By authenticating devices, data detection and entity authentication may be improved.

To authenticate devices and users thereof, a system may distribute entangled photons via transmission mediums (e.g., fiber optics, etc.) to a desired recipient (e.g., to be authenticated). The transmission medium may also be used to transmit general data (e.g., encoded on an optical carrier) that is interleaved with entangled photons to the recipients and/or other devices. The recipients of the entangled photons may measure the photons to obtain bit sequences corresponding to true random numbers. The recipients may use the bit sequences to generate and send authentication data usable to authenticate the recipient to another device. The other device (e.g., a sender of the entangled photons) may also receive a portion of the entangled photons (e.g., the recipient device and other device each receiving one of each pair of entangled photons) to obtain a copy of the bit sequences. With the copies of the bit sequence, the recipient and other device may use the respective copies of the bit sequences to, for example, authenticate each other, secure communications between the recipient and the other device, and otherwise reduce the likelihood of transmitting sensitive data to unintended recipients.

The entangled photon pairs may have a polarization relationship used by the recipient and other device to obtain the copies of the bit sequence. By utilizing a polarization relationship, other optical carriers may be simultaneously transmitted on the transmission medium along with the entangled photons. The system may utilize existing transmission mediums, such as optical fibers, to provide for bit sequence distribution in the distributed system.

In one example embodiment, a method is provided for authentication between an initiating device and a participating device operably connected to each other with a transmission medium used to transmit data between the initiating device and the participating device. The method includes generating, by generation hardware of the initiating device, a pair of entangled photons, the pair of entangled photons having a polarization relationship, and a polarization of each entangled photon of the pair of entangled photons being unknown when generated. The method further includes transmitting, by communication hardware of the initiating device and via the transmission medium, a first entangled photon of the pair of entangled photons to the participating device. The method also includes obtaining, by measurement hardware of the initiating device, a bit of a bit sequence based on a polarization of a second entangled photon of the pair of entangled photons, the polarization relationship fixing the polarizations of the pair of entangled photons upon a first polarization measurement of either entangled photon of the pair of entangled photons. The method further includes obtaining, by the communication hardware, authentication data from the participating device, the authentication data being based, at least in part, on the polarization of the first of the pair of entangled photons. The method also includes determining, by authentication circuitry of the initiating device, an authentication status of the participating device with the authentication data and the bit sequence, the authentication status indicating whether the participating device has an identity presumed by the initiating device.

In another example embodiment, an apparatus for secure distribution of data to a participating device via a transmission medium is provided. The apparatus includes generation hardware that generates a pair of entangled photons, the pair of entangled photons having a polarization relationship, and a polarization of each entangled photon of the pair of entangled photons being unknown when generated. The apparatus also includes communication hardware that transmits a first entangled photon of the pair of entangled photons to the participating device via the transmission medium. The apparatus further includes measurement hardware that obtains a bit of a bit sequence based on a polarization of a second entangled photon of the pair of entangled photons, the polarization relationship fixing the polarizations of the pair of entangled photons upon a first polarization measurement of either entangled photon of the pair of entangled photons. The communication hardware also obtains authentication data from the participating device, the authentication data being based, at least in part, on the polarization of the first entangled photon of the pair of entangled photons. The apparatus also includes authentication circuitry that determines an authentication status of the participating device with the authentication data and the bit sequence, the authentication status indicating whether the participating device has an identity presumed by the initiating device.

In a further example embodiment, an apparatus for secure distribution of data to a participating device via a transmission medium is provided. The apparatus includes a first means for generating a pair of entangled photons, the pair of entangled photons having a polarization relationship, and a polarization of each entangled photon of the pair of entangled photons being unknown when generated. The apparatus also includes a second means for transmitting a first entangled photon of the pair of entangled photons to the participating device via the transmission medium. The apparatus further includes a third means for obtaining a bit of a bit sequence based on a polarization of a second entangled photon of the pair of entangled photons, the polarization relationship fixing the polarizations of the pair of entangled photons upon a first polarization measurement of either of the pair of entangled photons. The second means is also for obtaining authentication data from the participating device, the authentication data being based, at least in part, on the polarization of the first entangled photon of the pair of entangled photons. The apparatus also includes a fourth means for determining an authentication status of the participating device with the authentication data and the bit sequence, the authentication status indicating whether the participating device has an identity presumed by the initiating device.

In another example embodiment, a method for authentication between an initiating device and a participating device operably connected to each other with a transmission medium used to transmit data between the initiating device and the participating device is provided. The method includes receiving, by communication hardware of the participating device, a first entangled photon from the initiating device, the first entangled photon being one of a pair of entangled photons having a polarization relationship, and a polarization of each entangled photon of the pair of entangled photons being unknown when the first entangled photon is received by the participating device. The method also includes impinging, by the communication hardware, the first entangled photon on a polarized beam splitter optically connected to a first optical path and a second optical path, the polarized beam splitter configured to direct horizontally polarized optical radiation along the first optical path and vertically polarized optical radiation along the second optical path. The method also includes obtaining, by measurement hardware of the participating device, a bit of a bit sequence with a single photon detector positioned on the first optical path. The method further includes providing, by the communication hardware, authentication data to the initiating device, the authentication data being based, at least in part, on the bit sequence.

In another example embodiment, an apparatus for secure reception of data from an initiating device via a transmission medium is provided. The apparatus includes communication hardware that receives a first entangled photon from the initiating device, the first entangled photon being one of a pair of entangled photons having a polarization relationship, and a polarization of each entangled photon of the pair of entangled photons being unknown when the first entangled photon is received by the apparatus; and impinges the first entangled photon on a polarized beam splitter optically connected to a first optical path and a second optical path, the polarized beam splitter being configured to direct horizontally polarized optical radiation along the first optical path and vertically polarized optical radiation along the second optical path. The apparatus also includes measurement hardware that obtains a bit of a bit sequence with a single photon detector positioned on the first optical path. The communication hardware also provides authentication data to the initiating device, the authentication data being based, at least in part, on the bit sequence.

In a further example embodiment, an apparatus for secure reception of data from an initiating device via a transmission medium is provided. The apparatus includes first means for receiving a first entangled photon from the initiating device, the first entangled photon being one of a pair of entangled photons having a polarization relationship, and a polarization of each entangled photon of the pair of entangled photons being unknown when the first entangled photon is received by the apparatus; and impinging the first entangled photon on a polarized beam splitter optically connected to a first optical path and a second optical path, the polarized beam splitter being configured to direct horizontally polarized optical radiation along the first optical path and vertically polarized optical radiation along the second optical path. The apparatus also includes a second means for obtaining a bit of a bit sequence with a single photon detector positioned on the first optical path. The first means is also for providing authentication data to the initiating device, the authentication data being based, at least in part, on the bit sequence.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for authenticating devices and/or users thereof.

FIG. 2A illustrates a schematic block diagram of example circuitry embodying a device that may perform various operations in accordance with some example embodiments described herein.

FIG. 2B illustrates a schematic block diagram of example hardware that may perform various operations in accordance with some example embodiments described herein.

FIG. 2C illustrates a schematic block diagram of example hardware that may perform various operations in accordance with some example embodiments described herein.

FIG. 2D illustrates a schematic block diagram of example hardware that may perform various operations in accordance with some example embodiments described herein.

FIG. 3A illustrates a schematic block diagram of example circuitry embodying a device that may perform various operations in accordance with some example embodiments described herein.

FIG. 3B illustrates a schematic block diagram of example hardware that may perform various operations in accordance with some example embodiments described herein.

FIG. 3C illustrates a schematic block diagram of example hardware that may perform various operations in accordance with some example embodiments described herein.

FIG. 4 illustrates an example communication environment in some example embodiments described herein.

FIG. 5 illustrates an example flowchart for authenticating a participating device, in accordance with some example embodiments described herein.

FIG. 6 illustrates an example flowchart for providing authentication data, in accordance with some example embodiments described herein.

FIGS. 7A-7C illustrates example operations of a system, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) hosted by a computing device that causes the computing device to operate as a server.

### Overview

As noted above, example embodiments described herein provide methods, apparatuses, systems, and computer program products are described herein that provide for authentication of devices and users thereof in a distributed system. The distributed system may allow the devices and users to provide and obtain various services including, for example, data distribution, voice transmission, and/or other types of computer implemented services. As part of these services, sensitive data may be distributed within the distributed system.

Traditionally, it has been difficult to authenticate devices in distributed systems by virtue of the distance between the devices and complexity of the environment. This has led to the unintended distribution of sensitive information to unintended recipients. Conventional approaches to device authentication rely on a combination of self-identification, cryptography, and communication security. These approaches taken together, however, are insufficient to prevent undesired distribution of sensitive data to unintended recipients.

Example embodiments may provide for the improvement of device authentication within distributed systems. In contrast to conventional techniques, the disclosed example embodiments may distribute entangled photons to devices (e.g., to-be-authenticated devices) prior to distribution of sensitive data. The entangled photons may be distributed over conventional transmission mediums (e.g., optical fibers) while data is also conventionally distributed over the transmission mediums with carrier signals.

The entangled photons may carry information in their respective polarizations thereby allowing some of the photons to be efficiently discriminated from optical carrier signals, which may be uniformly polarized. For example, carrier signals may consist essentially of vertically polarized waves or horizontally polarized waves. Consequently, devices that receive the entangled photons may be easily able to extract the photons having different polarizations from the carrier signals over conventional transmission mediums (e.g., optical fibers, free space, etc.). The devices that receive the entangled photons may use the photons to obtain bit sequences known to the devices attempting to authenticate them. Consequently, these devices may utilize the commonly known bit sequences to authenticate one another.

The entangled photons may, by virtue of the generation method, have polarizations corresponding to a true random distribution. In contrast to traditional sequence generation that are typically only pseudorandom in nature, the true random distribution of polarizations of the entangled photons may impart a true random character to the bit sequences derived from the polarizations of the entangled photons. Consequently, in addition to being usable for authentication, the bit sequences distributed in this manner may also be utilized to for communication security purposes. For example, the bit sequences may be utilized to obtain symmetric keys, may be used as one type pads, and/or may be otherwise used to secure communications between devices in the distributed system.

Although a high level explanation of the operations of example embodiments has been provided above, specific details regarding the configuration of such example embodiments are provided below.

### System Architecture

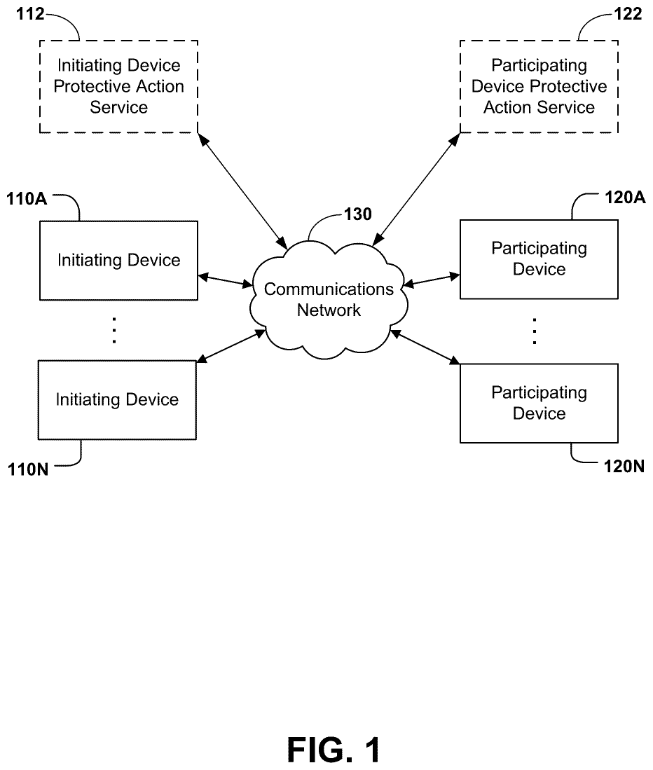

Example embodiments described herein may be implemented using any number and type of computing devices. To this end, FIG. 1 illustrates an example environment within which various embodiments may operate. As illustrated, the environment may include any number of initiating devices 110A-110N and participating devices 120A-120A. These devices may interact with one another to perform any number and types of services. When performing the services, the devices may authenticate one another. As used herein, the term initiating device refers to a device initiates authentication of another device (e.g., a participating device). Likewise, the term participating devices refers to a device that is participating in authentication initiated by another device. Any device may be an initiating device and/or a participating device (for example, a device may both be in the process of authenticating another device while also being authenticated by a different device) depending on their role, which may change over time.

Returning to the discussion of the services provided by these device, these devices may identify all, or a portion, of the devices participating in the services, authenticate the devices participating in the services, and/or perform other actions to reduce the likelihood of unintended actors participating in and/or receiving the services. As part of performing the services, any of the devices may transmit sensitive data to one another. By identifying, authenticating, and performing other actions, these devices may reduce the likelihood of sensitive data being distributed to unintended recipients.

The initiating devices 110A-110N may be implemented using any number (one, many, etc.) and types of computing devices known in the art, such as desktop or laptop computers, tablet devices, smartphones, or the like. The initiating devices may be associated with corresponding users (e.g., administrators, customers, representatives, other persons, etc.) that use the initiating devices 110A-110N to interact with one or more of the participating devices 120A-120N.

The users and/or applications hosted by the initiating devices may transmit sensitive data to the participating devices when interacting with them (and/or other devices). The sensitive data may include, for example, financial information, future plans, personal information, and/or other types of data that may be exploited by unintended recipients of the sensitive data. The unintended recipients may obtain the sensitive data by inadvertent transmission by the initiating devices or through intentional action by the unintended recipients to obtain the sensitive data. For example, the unintended recipients may impersonate other users and/or devices to obtain copies of the sensitive data. To reduce the likelihood of the sensitive data from being obtained by the unintended recipients, the initiating devices and the participating devices may perform one or more identity verification, authentication, and/or other actions (collectively the “protective actions”) as part of or with the services provided by the initiating devices 110A-110N and participating devices 120A-120N.

The participating devices 120A-120N may be implemented using any number and types of computing devices known in the art, such as desktop or laptop computers, tablet devices, smartphones, or the like. The participating devices 120A-120N may provide computer implemented services to and/receive computer implemented services from the initiating devices 110A, 110N and/or other devices.

Like the initiating devices 110A-110N, the participating devices 120A-120N may be associated with corresponding users (e.g., administrators, customers, representatives, other persons, etc.) that use the participating devices 120A-120N to interact with one or more of the initiating devices 110A-110N (and/or other devices). The users and/or applications hosted by the participating devices may transmit and/or receive sensitive data to or from the initiating devices when interacting with them (and/or other devices). To reduce the likelihood of distribution of sensitive data to unintended recipient, the participating devices may perform one or more identity verification, authentication, and/or other actions as part of or with the services provided by the participating devices 120A-120N.

The initiating devices 110A-110N and the participating devices 120A-120N may cooperatively provide various computer implemented services to accomplish desirable goals for their respective users. For example, consider a scenario in which an initiating devices is being used by a first trader at a first brokerage firm and a participating device is being used by a second trader at a second brokerage firm. The traders may desire to complete a transaction with each other. To do so, the first trader may use a voice over internet protocol (VOIP) service provided by the initiating device to open a voice channel with the participating device to communicate with the second trader. However, due to the advent of deep fake technology and others, the first trader may not be able to rely on recognition of the second trader's voice to sufficiently identify and/or authenticate that the first trader is actually communicating with the second trader. For example, a third party may use deep fake technology to communicate with the first trade with an auditory likeness of the second trader thereby lulling the first trader into disclosing sensitive information to the third party.

To reduce the likelihood of the aforementioned scenario from occurring, embodiments disclosed herein may provide for the performance of protective actions with specialized hardware. For example, when the voice channel is established (or prior to it being established), the protective actions may be performed in advance of exchange of sensitive information/data.

To perform the protective actions, in one or more embodiments, all or a portion of the initiating devices 110A-110N and the participating devices 120A-120N include specialized hardware for distributing bit sequences. The distributed bit sequences may include true random numbers usable, for example, to perform symmetric encryption for communication, device/user authentication, and/or other protective actions. The specialized hardware may enable the initiating devices 110A-110N and/or participating devices 120A-120N to generate, distribute, and/or use entangled photon pairs for bit sequence distribution purposes. The specialized hardware may also enable the entangled photon pairs to be concurrently distributed over transmission mediums with other optical signals (or other types of signals) used for general data transmission among any number of devices. As will be discussed in greater detail below, the true random numbers may be encoded in the polarizations (or other characteristics) of the entangled photon pairs. However, the true random numbers may be encoded differently with, for example, their emission times, energy levels, or other characteristics.

In some embodiments, the system of FIG. 1 may include an initiating device protective action service 112 and/or a participating device protective action service 122 (drawn with dashed boarders to indicate that these components may not be present in all embodiments). In such embodiments, some or all of the initiating devices 110A-110N and participating devices 120A-120N do not include specialized hardware for performing the protective actions. Rather, the initiating device protective action service 112 and/or a participating device protective action service 122 may include the specialized hardware and may cooperate with the initiating devices 110A-110N and participating devices 120A-120N, respectively, to perform the protective actions on their behalf.

For example, in some embodiments, the system of FIG. 1 may represent a data center environment in which the initiating devices 110A-110N and participating devices 120A-120N are implemented with server in rack mounted chassis in racks. In such a scenario, the initiating device protective action service 112 and participating device protective action service 122 may be implemented as top of rack (TOR) switches/routers operably connected to communications network 130. Each of the initiating devices and participating devices may be operably connected to different TOR switches via a local area network (e.g., via multi-homed Ethernet links to the respective TOR switches).

In another example, in some embodiments, the system of FIG. 1 may represent a communications switching environment in which the initiating devices 110A-110N and participating devices 120A-120N are implemented with computing devices or other communications devices (e.g., internet protocol phones) distributed throughout a deployment (e.g., different office environments). In such a scenario, the initiating device protective action service 112 and participating device protective action service 122 may be implemented as voice switches or other types of communication switching systems (e.g., public branch exchanges) operably connected to communications network 130. Each of the initiating devices and participating devices may be operably connected to the respective communication switching systems via a local communications network (e.g., data unit or link switching systems).

Like the initiating devices 110A-110N and participating devices 120A-120N, the initiating device protective action service 112 and/or a participating device protective action service 122 may be implemented using any number and types of computing devices known in the art, such as desktop or laptop computers, tablet devices, smartphones, or the like. As will be discussed in greater detail below, these services may include specialized hardware usable in conjunction with computing devices to provide protective action services such as, for example, distribution of true random numbers.

To facilitate communications, any of the devices shown in FIG. 1 may be operably connected to each other with communications network 130. Communications network 130 may facilitate communications with one or more wired and/or wireless networks implemented using any suitable communications technology. In one embodiment, communications network 130 includes any number and type of transmission mediums (e.g., electrical cabling, optical cabling, free space channels, etc.) through which signals (e.g., electrical, optical, etc.) on which data is encoded are distributed amongst the devices. The communications network 130 may be implemented using any number and types of communication protocols.

While the initiating devices and participating devices are illustrated in FIG. 1 as being connected to communications network 130 directly, these devices may be indirectly connected to communications network 130 through initiating device protective action service 112 and participating device protective action service 122, respectively.

Although FIG. 1 illustrates an environment and implementation in which various functionalities are performed by different devices, in some embodiments some or all of the functionalities of the initiating devices 110A-110N, participating devices 120A-120N, initiating device protective action service 112, and participating device protective action service 122 are aggregated into a single device.

### Example Implementing Apparatuses

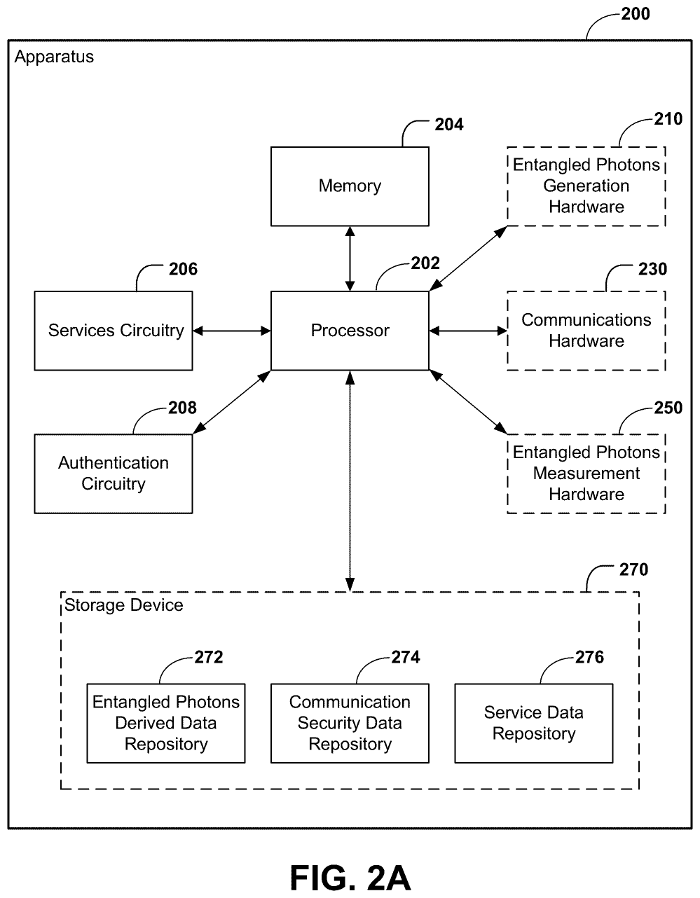

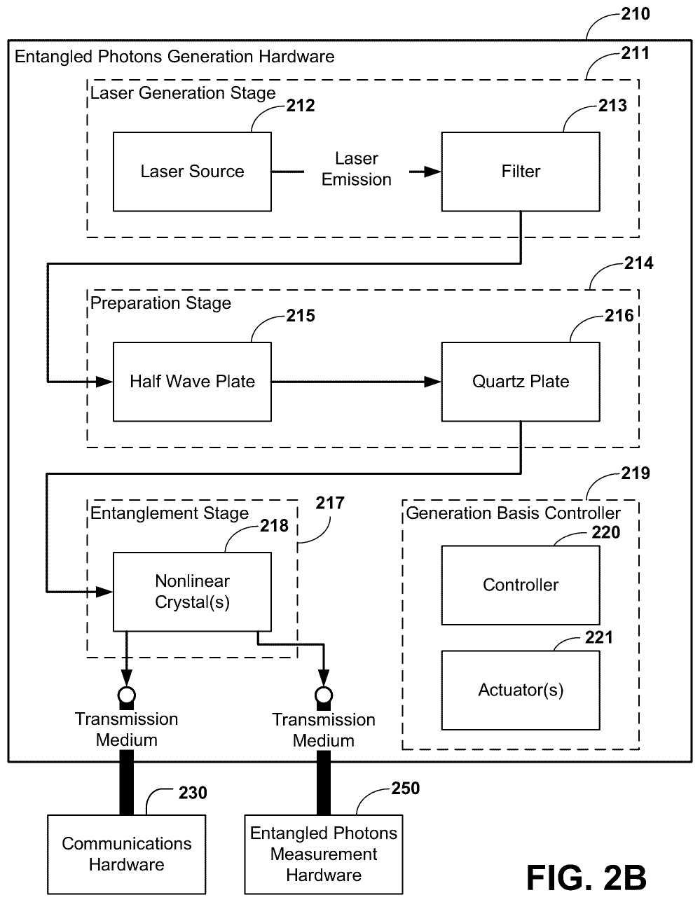

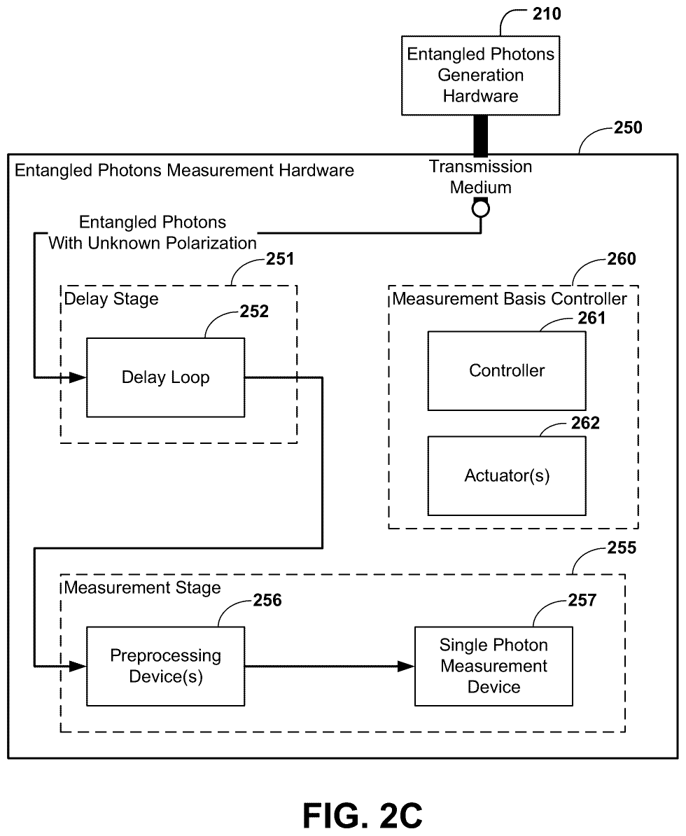

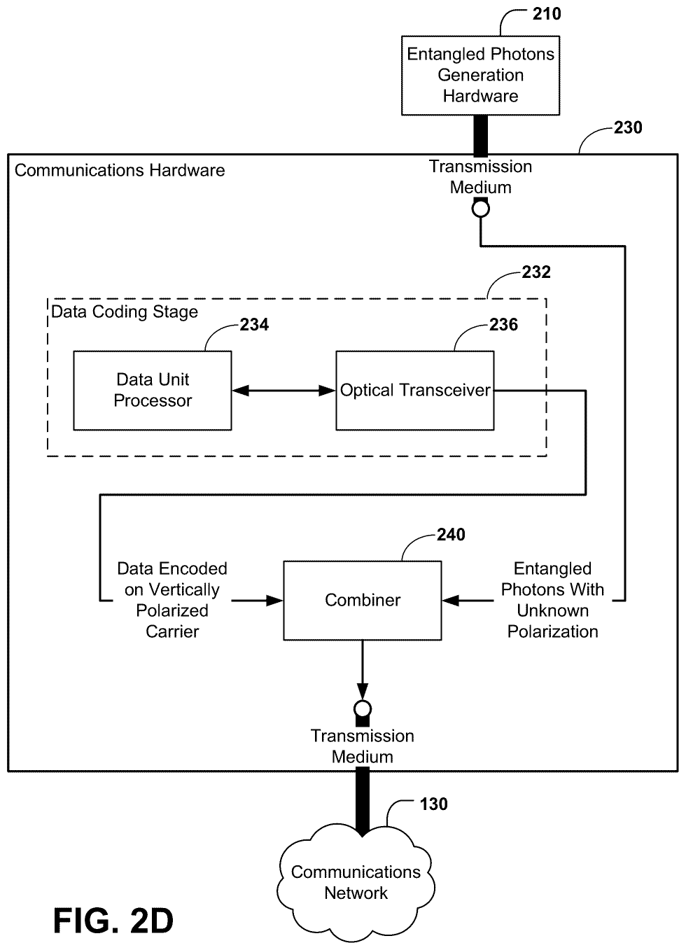

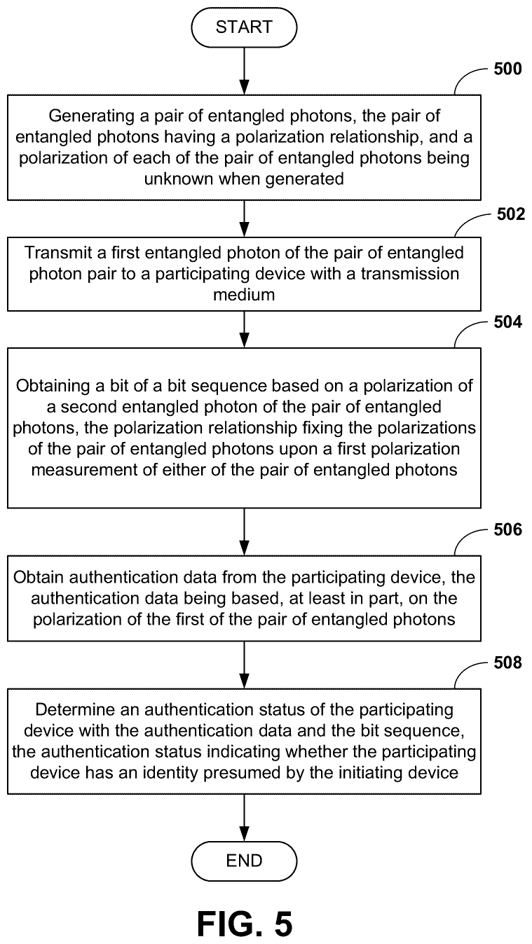

Any of initiating devices 110A-110N may be embodied by one or more computing devices or servers, shown as apparatus 200 in FIG. 2A. As illustrated in FIG. 2A, the apparatus 200 may include processor 202, memory 204, services circuitry 206, authentication circuitry 208, entangled photons generation hardware 210, communications hardware 230, entangled photons measurement hardware 250, and storage device 270, each of which will be described in greater detail below. While the various components are only illustrated in FIG. 2A as being connected with processor 202, it will be understood that the apparatus 200 may further comprises a bus (not expressly shown in FIG. 2A) for passing information amongst any combination of the various components of the apparatus 200. The apparatus 200 may be configured to execute various operations described above in connection with FIG. 1 and below in connection with FIGS. 5-7C.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor (e.g., software instructions stored on a separate or integrated storage device 270). In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The services circuitry 206 may be any means such as a device or circuitry embodied in either hardware or a combination of hardware and software that is configured to perform any number of services in isolation or in cooperation with other devices operably connected to apparatus 200. When providing the services, services circuitry 206 may cause sensitive data (e.g., as part of services data) to be generated and/or stored in a service data repository 276 in storage device 270 and/or cause sensitive data to be transmitted to other devices with communications hardware 230. For example, the services circuitry 206 may provide electronic communications services (e.g., text based messaging, VOIP, etc.), database services, and/or other services which may involve the sending and/or receipt of sensitive data via communications hardware 230 with subsequent storage in the service data repository 276.

Prior to transmitting sensitive data, the services circuitry 206 may invoke the functionality of the authentication circuitry 208. Depending on whether the authentication circuitry 208 is able to authenticate a device or user with which the services circuitry 206 is interacting, the services circuitry 206 may or may not transmit the sensitive data. Doing so may reduce the likelihood of distributing the sensitive data to unintended receivers.

The authentication circuitry 208 may be any means such as a device or circuitry embodied in either hardware or a combination of hardware and software that is configured to perform protective actions for authentication of other devices and/or users of other devices. To authenticate other devices, the authentication circuitry 208 may invoke the functionality of the entangled photons generation hardware 210, communications hardware 230, and/or entangled photons measurement hardware 250 to generate, transmit, and measure entangled photons to distribute true random numbers to apparatus 200 and other devices. The authentication circuitry 208 may store the true random numbers as part of entangled photons derived data repository 272 in storage device 270 and keys (or other information based on the true random numbers) in communication security data repository 274 in storage device 270. The stored data may be used to, for example, authenticate a device or user thereof, secure communications with another device, and/or for other purposes.

The entangled photons generation hardware 210 may be any means such as one or more devices or circuitry embodied in either hardware or a combination of hardware and software that is configured to generate entangled photon pairs. The entangled photon pairs may be used to (i) generate random numbers and (ii) distribute the random numbers to the apparatus 200 and another device. The functionality of the entangled photons generation hardware 210 may be invoked by, for example, the authentication circuitry 208. Refer to FIG. 2B for additional details regarding entangled photons generation hardware 210.

The communications hardware 230 may be any means such as a device or circuitry embodied in either hardware or a combination of hardware and software that is configured to receive and/or transmit data from/to a network and/or any other device, circuitry, or module in communication with the apparatus 200. In this regard, the communications hardware 230 may include, for example, a network interface for enabling communications with a wired or wireless communication network. For example, the communications hardware 230 may include one or more network interface cards, data unit processors, antennas, buses, switches, routers, modems, and supporting hardware and/or software, or any other device suitable for enabling communications via a network. Furthermore, the communications hardware 230 may include the processing circuitry for causing transmission of such signals to a network or for handling receipt of signals received from a network.

Additionally, communications hardware 230 may include combiners or other devices for simultaneously transmission of entangled photons from the entangled photons generation hardware 210 and carrier signals on which data (which may include sensitive data) is encoded on a transmission medium such as an optical fiber, free space, or other medium. Refer to FIG. 2D for additional details regarding communications hardware 230.

The entangled photons measurement hardware 250 may be any means such as one or more devices or circuitry embodied in either hardware or a combination of hardware and software that is configured to measure entangled photons. The entangled photons may be measured to facilitate distribution of true random numbers to both initiating and participating devices (each may measure respective photons of entangled photon pairs thereby each obtaining copies of true random number sequences). The entangled photons may be generated by the entangled photons generation hardware 210 and/or other devices. The functionality of the entangled photons measurement hardware 250 may be invoked by the authentication circuitry 208 as part of performing protective actions. Refer to FIG. 2C for additional details regarding entangled photons measurement hardware 250.

Finally, the apparatus 200 may include storage device 270 that stores data structures used by services circuitry 206 and authentication circuitry 208 to provide their functionalities. Storage device 270 may be a non-transitory storage and include any number and types of physical storage devices (e.g., hard disk drives, tape drives, solid state storage devices, etc.) and/or control circuitry (e.g., disk controllers usable to operate the physical storage devices and/or provide storage functionality such as redundancy, deduplication, etc.).

Storage device 270 may store entangled photons derived data repository 272, communication security data repository 274, and service data repository 276. Entangled photons derived data repository 272 may store any quantity of random numbers obtained by authentication circuitry 208 using entangled photons generation hardware 210 and entangled photons measurement hardware 250. Communication security data repository 274 may include any type and quantity of data usable to secure communication with communications hardware 230. For example, communication security data repository 274 may include symmetric encryption keys generated using some of the random numbers stored in entangled photons derived data repository 272. Service data repository 276 may include any type and quantity of data used by services circuitry 206. The data may include any type and quantity of sensitive data. Any of the repositories 272, 274, 276 may be implemented using any number and types of data structures (e.g., database, lists, tables, linked lists, etc.).

While entangled photons generation hardware 210, communications hardware 230, entangled photons measurement hardware 250, and storage device 270 are illustrated in FIG. 2A as being a part of apparatus 200, any of these components may be parts of other devices (as indicated by being drawn with dashed outlining). For example, entangled photons generation hardware 210, communications hardware 230, and/or entangled photons measurement hardware 250 may be implemented as part of initiating device protective action service 112 which may be operably connected to apparatus 200 and the circuitry therein (e.g., via a network, local bus, etc.). Similarly, storage device 270 may be a part of a different device operably connected to apparatus 200.

Although components 202-270 are described in part using functional language, it will be understood that the particular implementations necessarily include the use of particular hardware. It should also be understood that certain of these components 202-270 may include similar or common hardware. For example, the services circuitry 206 and authentication circuitry 208 may each at times leverage use of the processor 202, memory 204, entangled photons generation hardware 210, communications hardware 230, entangled photons measurement hardware 250, and/or storage device 270, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may in addition refer to software instructions that configure the hardware components of the apparatus 200 to perform the various functions described herein.

Although services circuitry 206 and authentication circuitry 208 may leverage processor 202 or memory 204 as described above, it will be understood that any of these elements of apparatus 200 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or memory 204, or communications hardware 230 for enabling any functions not performed by special-purpose hardware elements. In all embodiments, however, it will be understood that the processor 202, memory 204, entangled photons generation hardware 210, communications hardware 230, entangled photons measurement hardware 250, and storage device 270 are implemented via particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. Thus, some or all of the functionality described herein may be provided by third party circuitry. For example, a given apparatus 200 may access one or more third party circuitries via any sort of networked connection that facilitates transmission of data and electronic information between the apparatus 200 and the third party circuitries. In turn, that apparatus 200 may be in remote communication with one or more of the other components describe above as comprising the apparatus 200.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 200 as described in FIG. 2A, that loading the software instructions onto a computing device or apparatus produces a special-purpose machine comprising the means for implementing various functions described herein.

Turning to FIG. 2B, a diagram of an example entangled photons generation hardware 210 is illustrated. As noted above, entangled photons generation hardware 210 may provide for the generation of pairs of photons that are entangled. Once generated, the entangled photon pairs may be utilized to distribute true random numbers to apparatus 200 and a second device (e.g., apparatus 300, discussed below). To provide this functionality, entangled photons generation hardware 210 may include a laser generation stage 211, a preparation stage 214, an entanglement stage 217, and a generation basis controller 219. Each of these components is discussed below.

The laser generation stage 211 may be any means such as a device that is configured to generate and/or condition a laser emission. The laser generation stage 211 may include a laser source 212 and a filter 213. The laser source 212 may generate a laser emission (e.g., coherent optical radiation). The laser source 212 may any type of laser generating device (e.g., a gas laser, chemical laser, excimer laser, solid-state laser, fiber laser, photonic crystal laser, etc.) The filter 213 may be a physical device (e.g., a laser line filter) to optically filter the laser emission selectively for a predetermined frequency. The laser source 212 and filter 213 may be aligned with one another along a transmission path of the laser emission.

The preparation stage 214 may be any means such as a device that is configured to prepare a laser emission for generation of entangled photons. The preparation stage 214 may include a half wave plate 215 and a quartz plate 216. These devices may be positioned along the transmission path of the laser emission to condition the polarization of the laser, remove unwanted spectral components, collimate the laser emission, and/or otherwise prepare the laser emission for impingement on a nonlinear crystal or other structure for entangled photon pair generation.

The entanglement stage 217 may be any means such as a device that is configured to generate entangled photons with a laser emission. In one or more embodiments, the entanglement stage 217 is configured to generate entangled photon pairs having a polarization relationship. However, the entangled photons may have other relationships (e.g., energy, time, etc.). The polarization relationship may require, for example, that each entangled photon of the entangled photon pairs have a same or different polarization with respect to the other entangled photon of the respective entangled photon pairs. When generated, the pairs of entangled photons may be in an indeterminate state (e.g., unmeasured).

The entanglement stage 217 may include one or more nonlinear crystals 218 positioned in the optical path along which the laser emission travels. The non-linear crystals 218 may be configured to induce spontaneous parametric down-conversion of the laser to generate the entangled photon pairs. The entangled photon pairs may have a type II polarization correlation (e.g., a polarization relationship) and may be constrained with known trajectories from the non-linear crystals 218 such that the resulting entangled photons of each pair may be directed along different optical paths. Each of the optical paths may be aligned with respective transmission mediums to direct one of the entangled photons of each entangled photon pair to the communications hardware 230 and the other entangled photon of each entangled photon pair to the entangled photons measurement hardware 250. The nonlinear crystals 218 may be formed from any suitable material such as, for example, beta-barium borate, lithium niobate, or other material. The transmission mediums may be, for example, optical fibers, free space, or other structures. The resulting entangled photon pairs may be in an indeterminate polarization state upon generation and the distribution of the resulting polarization states of the entangled photon pairs, once measured, may be truly random by virtue of the generation process.

The generation basis controller 219 may be any means such as a device that is configured to modify the basis used to generate the entangled photon pairs. To appropriately measure the entangled photon pairs, information regarding the generation basis may need to be known. The generation basis controller 219 may include, for example, a controller 220 and one or more actuators 221. The actuators 221 may be positioned to modify the positioning and/or orientation of the half wave plate 215, quartz plate 216, nonlinear crystals 218, and/or transmission mediums with respect to one another. The actuators 221 may be operably connected to the controller 220 such that the controller 220 may operate the actuators 221 to modify the positioning and/or orientation of the aforementioned components. The controller 220 may be operably connected to the authentication circuitry 208 which may over time modify the generation basis for entangled photon pair generation. Modifying the generation basis for the entangled photon pairs may change how the entangled photon pairs are launched onto the transmission medium, may change the energy level of the entangled photon pairs, and/or may otherwise modify characteristics of the entangled photon pairs that may need to be known to measure the entangled photon pairs.

Turning to FIG. 2C, a diagram of example entangled photons measurement hardware 250 is illustrated. As noted above, the entangled photons measurement hardware 250 may facilitate measurement of one entangled photon of each entangled photon pair generated by the entangled photons generation hardware 210. Measuring one of the entangled photons for each of the entangled photon pairs may distribute true random numbers to the apparatus 200. When entangled photons are received by the entangled photons measurement hardware 250, the polarization of the photons may be indeterminate and/or unknown to the apparatus 200. To measure entangled photons, the entangled photons measurement hardware 250 may include a delay stage 251, measurement stage 255, and measurement basis controller 260. Each of these components is discussed below.

The delay stage 251 may be any means such as a device that is configured to delay arrival of entangled photons at a measurement device. The delay may be configured to, for example, prevent entangled photon pairs from being measured by the measurement device (prior to measurement of one entangled photon by another device) or to set a timing of when one entangled photon of an entangled photon pair is measured. The delay stage 251 may include a delay loop 252 (e.g., a string of optical fiber, a free space transmission path bounded with mirrors, etc.). The delay loop may be optically coupled to a transmission medium to receive entangled photons from the entangled photons generation hardware 210.

The measurement stage 255 may be any means such as a device that is configured to measure one entangled photon of entangled photon pairs. The measurement stage 255 may receive the entangled photons delayed by the delay stage 251. The measurement stage 255 may include one or more preprocessing devices 256 and a single photon measurement device 257. Photons received by the measurement stage 255 may be impinged on the preprocessing devices 256. The preprocessing devices 256 may perform any optical function (e.g., filtering, polarizing, polarization filtering, etc.) in preparation for measurement of the photons. In one embodiment, the preprocessing devices 256 filters out photons that do not have a particular polarization such that only photons having the particular polarization impinge on the single photon measurement device 257. The single photon measurement device 257 may measure photons that impinge on it. The single photon measurement device 257 may be configured to only measure photons from the preprocessing devices 256. For example, single photon measurement device 257 may be shrouded and/or optically coupled to the preprocessing devices 256. Consequently, the single photon measurement device 257 may only count photons that have the particular polarization. The single photon measurement device 257 may be implemented using single-photon detectors such as, for example, biased semiconductor junctions, super conducting wires, nanowires, and/or other types of devices.

Entangled photons may be generated by the entangled photons generation hardware at a predetermined rate. The aforementioned rate may be used to determine, for different points in time, the value of bits of a bit sequence corresponding to the different points in time. For example, detection of a photon by the single photon measurement device 257 during a period of time (e.g., when a photon of an entangled photon pair is expected to arrive at the single photon measurement device) may be treated as the value of a bit being a “1” whereas not detecting a photon during the period of time may be treated as the value of the bit being a “0”. Thus, the combination of preprocessing devices and single photon measurement device may provide for counting of photons having a particular polarization and not counting photons having other polarizations.

The measurement basis controller 260 may be any means such as a device that is configured to modify the basis used to measure photons. To appropriately measure entangled photon pairs, information regarding the generation basis may need to be known. For example, the launch angle along a transmission medium may need to be known to set a corresponding measurement angle from the transmission medium. If not properly set, the photons may not be detectable. The measurement basis controller 260 may include, for example, a controller 261 and one or more actuators 262. The actuators 262 may be positioned to modify the positioning and/or orientation of the preprocessing devices 256 and/or transmission mediums with respect to one another. The actuators 262 may be operably connected to the controller 261 such that the controller 261 may operate the actuators 262 to modify the positioning and/or orientation of the aforementioned components. The controller 261 may be operably connected to the authentication circuitry 208 which may over time modify the measurement basis to correspond to the generation basis for entangled photon pairs. Information regarding the generation and measurement basis may be stored in the communications security data repository 274. Similar information may be stored in corresponding participating device repositories.

Turning to FIG. 2D, a diagram of an example communications hardware 230 is illustrated. The communications hardware 230 may facilitate communications between apparatus 200 and other devices and distribution of one entangled photon of entangled photon pairs to other devices. The communications hardware 230 may include a data coding stage 232 and a combiner 240. Each of these components is discussed below.

The data coding stage 232 may be any means such as a device that is configured to send data to and receive data from other devices. For example, when services circuitry 206 needs to send data to other devices, the data coding stage 232 may encapsulate the data in accordance with a communication scheme and transmit the data over communications network 130 to other devices. The data coding stage 232 may include a data unit processor 234 and an optical transceiver 236 (and/or other devices such as electrical transceivers). The data unit processor 234 may be a communication protocol compatible communications unit that is capable of appropriately encapsulating data (e.g., adding headers with control information) and transmitting the encapsulated data across a network to another device. Similarly, the data unit processor 234 may be capable of extracting the payload from encapsulated data received from other devices. The optical transceiver 236 (and/or other transceivers) may generate an optical carrier (e.g., vertically polarized optical radiation or horizontally polarized optical radiation) and modulate the generated optical carrier to transmit the encapsulated data. Similarly, the optical transceiver 236 may down convert received optical signals to provide encapsulated data to the data unit processor 234.

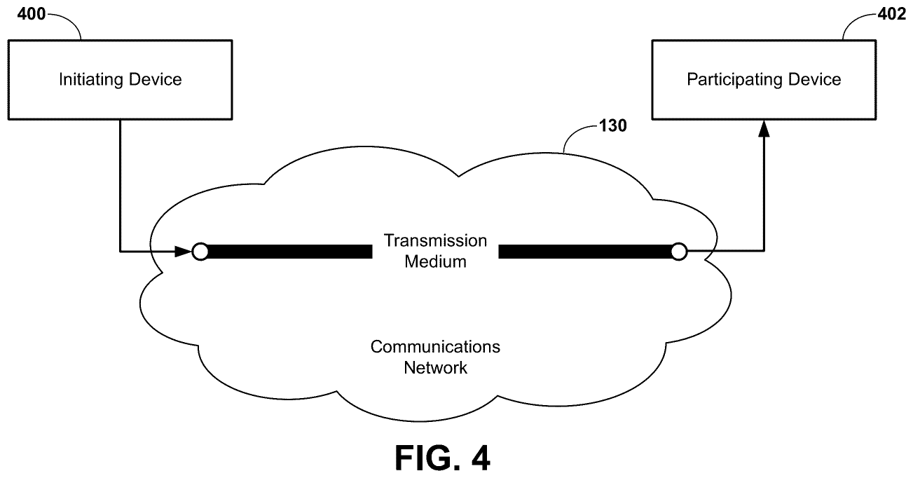

The combiner 240 may be any means such as a device that is configured to combine the data encoded on vertically polarized carriers (or optically polarized carriers, depending on how the optical carriers are generated) generated by the optical transceiver 236 with one entangled photon of entangled photon pairs generated by the entangled photons generation hardware 210. The combined optical radiation may then be transmitted via a transmission medium to the communications network 130. In this manner, both data (e.g., encoded on an optical carrier) and entangled photons may be simultaneously transmitted to another device (e.g., a participating device). The optical carrier may be uniformly polarized whereas the entangled photons may have varying polarizations. Consequently, the entangled photons that have a different polarization from the polarization of the optical carrier may be discriminated on this basis. Refer to FIG. 4 for additional details regarding transmission of optical radiation with the communications network 130.

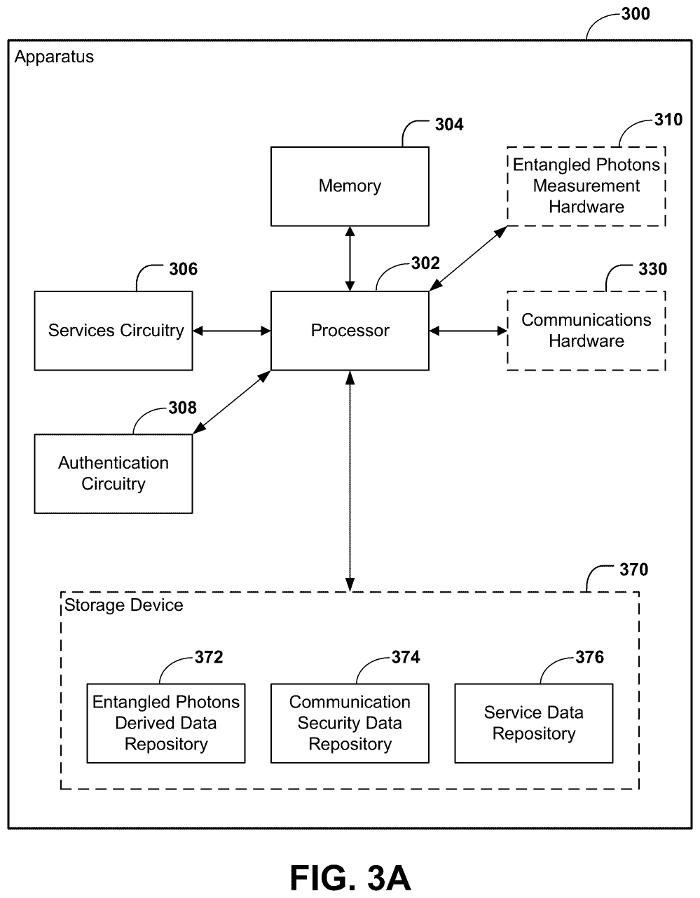

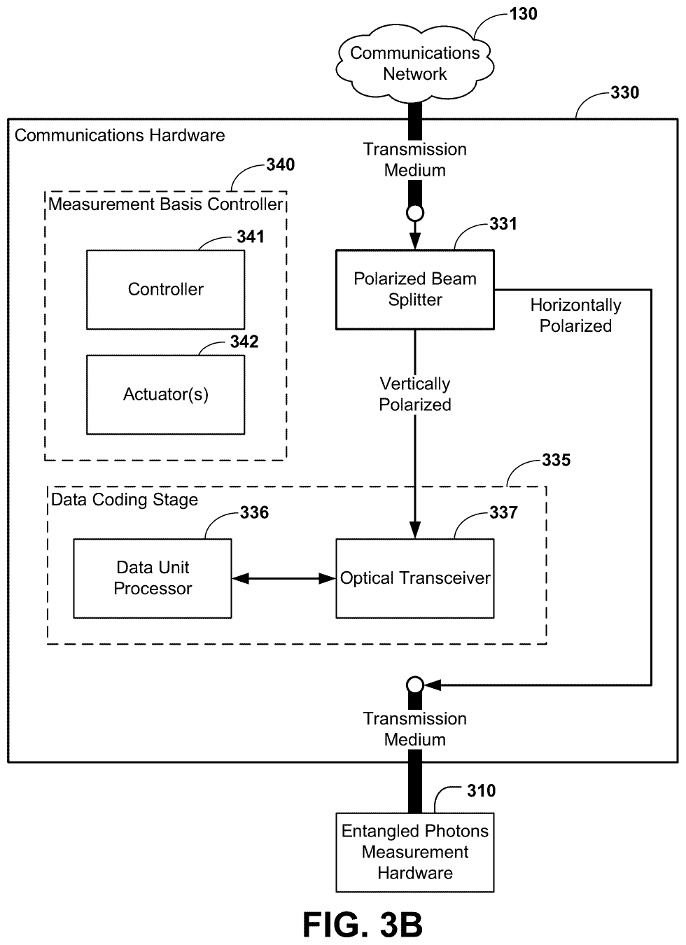

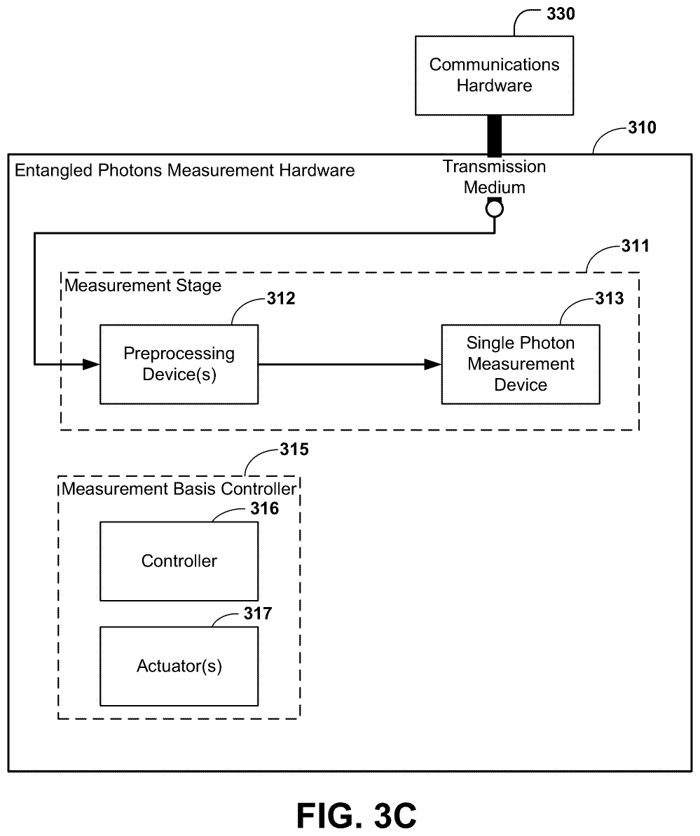

Returning to the discussion of FIG. 1, any of participating devices 120A-120N may be embodied by one or more computing devices or servers, shown as apparatus 300 in FIG. 3A. As illustrated in FIG. 3A, the apparatus 300 may include processor 302, memory 304, services circuitry 306, authentication circuitry 308, entangled photons measurement hardware 310, communications hardware 330, and storage device 370, each of which will be described in greater detail below. While the various components are only illustrated in FIG. 3A as being connected with processor 302, it will be understood that the apparatus 300 may further comprise a bus (not expressly shown in FIG. 3A) for passing information amongst any combination of the various components of the apparatus 300. The apparatus 300 may be configured to execute various operations described above in connection with FIG. 1 and below in connection with FIGS. 5-7C.

The processor 302 (and/or co-processor or any other processor assisting or otherwise associated with the processor) may be in communication with the memory 304 via a bus for passing information amongst components of the apparatus. The processor 302 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 300, remote or “cloud” processors, or any combination thereof.

The processor 302 may be configured to execute software instructions stored in the memory 304 or otherwise accessible to the processor (e.g., software instructions stored on a separate or integrated storage device 370). In some cases, the processor may be configured to execute hard-coded functionality. As such, whether configured by hardware or software methods, or by a combination of hardware with software, the processor 302 represent an entity (e.g., physically embodied in circuitry) capable of performing operations according to various embodiments of the present invention while configured accordingly. Alternatively, as another example, when the processor 302 is embodied as an executor of software instructions, the software instructions may specifically configure the processor 302 to perform the algorithms and/or operations described herein when the software instructions are executed.

Memory 304 is non-transitory and may include, for example, one or more volatile and/or non-volatile memories. In other words, for example, the memory 304 may be an electronic storage device (e.g., a computer readable storage medium). The memory 304 may be configured to store information, data, content, applications, software instructions, or the like, for enabling the apparatus to carry out various functions in accordance with example embodiments contemplated herein.

The services circuitry 306 may be any means such as a device or circuitry embodied in either hardware or a combination of hardware and software that is configured to perform any number of services in isolation or in cooperation with other devices operably connected to apparatus 300. When providing the services, services circuitry 306 may cause sensitive data to be generated and/or stored in a service data repository 376 in storage device 370 and/or cause sensitive data to be transmitted to other devices or received from other devices with communications hardware 330. For example, the services circuitry 306 may provide electronic communications services (e.g., text based messaging, VOIP, etc.), database services, and/or other services which may involve the sending and/or receipt of sensitive data via communications hardware 330 with subsequent storage in the service data repository 376.

Prior to transmitting sensitive data, the services circuitry 306 may invoke the functionality of the authentication circuitry 308. Depending on whether the authentication circuitry 308 is able to authenticate a device or user with which the services circuitry 306 is interacting, the services circuitry 306 may or may not transmit the sensitive data. Doing so may reduce the likelihood of distributing the sensitive data to unintended receivers.

The authentication circuitry 308 may be any means such as a device or circuitry embodied in either hardware or a combination of hardware and software that is configured to perform protective actions for authentication of apparatus 300 to other devices and other devices to apparatus 300 (and/or users thereof). To authenticate these devices, the authentication circuitry 308 may invoke the functionality of the entangled photons measurement hardware 310 and/or the communications hardware 330 to receive and measure entangled photons to obtain true random numbers from another device (e.g., apparatus 200). The authentication circuitry 308 may store the true random numbers as part of entangled photons derived data repository 372 in storage device 370 and keys or other information based on the true random numbers in communication security data repository 374 in storage device 370. The stored data may be used to, for example, to authenticate the apparatus 300 or user thereof to another device (e.g., apparatus 200 by generating and sending authentication based on the true random numbers), to secure communications with other devices, and/or for other purposes.

The entangled photons measurement hardware 310 may be any means such as one or more devices or circuitry embodied in either hardware or a combination of hardware and software that is configured to measure entangled photons. The entangled photons may be received from other devices with communications hardware 330. The functionality of the entangled photons measurement hardware 310 may be invoked by the authentication circuitry 308 as part of performing protective actions. Refer to FIG. 3C for additional details regarding entangled photons measurement hardware 310.

The communications hardware 330 may be any means such as a device or circuitry embodied in either hardware or a combination of hardware and software that is configured to receive and/or transmit data from/to a network and/or any other device, circuitry, or module in communication with the apparatus 300. In this regard, the communications hardware 330 may include, for example, a network interface for enabling communications with a wired or wireless communication network. For example, the communications hardware 330 may include one or more network interface cards, data unit processors, antennas, buses, switches, routers, modems, and supporting hardware and/or software, or any other device suitable for enabling communications via a network. Furthermore, the communications hardware 330 may include the processing circuitry for causing transmission of such signals to a network or for handling receipt of signals received from a network.

Additionally, communications hardware 330 may include devices for simultaneously receiving entangled photons and carrier signals on which the data (which may include sensitive data) is encoded on a transmission medium such as an optical fiber or free space. Refer to FIG. 2B for additional details regarding communications hardware 330.

Finally, the apparatus 300 may include storage device 370 that stores data structures used by services circuitry 306 and authentication circuitry 308 to provide their functionalities. Storage device 370 may be a non-transitory storage and include any number and types of physical storage devices (e.g., hard disk drives, tape drives, solid state storage devices, etc.) and/or control circuitry (e.g., disk controllers usable to operate the physical storage devices and/or provide storage functionality such as redundancy, deduplication, etc.).

Storage device 370 may store entangled photons derived data repository 372, communication security data repository 374, and service data repository 376. Entangled photons derived data repository 272 may store any quantity of random numbers obtained by authentication circuitry 308 using entangled photons measurement hardware 310 (e.g., with entangled photons from other devices such as apparatus 200). Communication security data repository 374 may include any type and quantity of data usable to secure communication with communications hardware 330 and/or to authenticate apparatus 300 to other device. For example, communication security data repository 374 may include symmetric encryption keys generated using some of the random numbers stored in entangled photons derived data repository 372 and/or authentication data that may be transmitted to other devices (e.g., from which the entangled photons are received) for authentication of apparatus 300. Service data repository 376 may include any type and quantity of data used by services circuitry 306. The data may include any type and quantity of sensitive data. Any of the repositories 372, 374, 376 may be implemented using any number and types of data structures (e.g., database, lists, tables, linked lists, etc.).

While entangled photons measurement hardware 310, communications hardware 330, and storage device 370 are illustrated in FIG. 3A as being a part of apparatus 300, any of these components may be parts of other devices (as indicated by being drawn with a dashed outline). For example, entangled photons measurement hardware 310 and/or communications hardware 330 may be implemented as part of participating device protective action service 122 which may be operably connected to apparatus 300. Similarly, storage device 370 may be a part of a different device operably connected to apparatus 300.

Although components 302-370 are described in part using functional language, it will be understood that the particular implementations necessarily include the use of particular hardware. It should also be understood that certain of these components 302-370 may include similar or common hardware. For example, the services circuitry 306 and authentication circuitry 308 may each at times leverage use of the processor 302, memory 304, entangled photons measurement hardware 310, communications hardware 330, and/or storage device 370, such that duplicate hardware is not required to facilitate operation of these physical elements of the apparatus 300 (although dedicated hardware elements may be used for any of these components in some embodiments, such as those in which enhanced parallelism may be desired). Use of the terms “circuitry” and “hardware” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may in addition refer to software instructions that configure the hardware components of the apparatus 300 to perform the various functions described herein.

Although services circuitry 306 and authentication circuitry 308 may leverage processor 302 or memory 304 as described above, it will be understood that any of these elements of apparatus 300 may include one or more dedicated processor, specially configured field programmable gate array (FPGA), or application specific interface circuit (ASIC) to perform its corresponding functions, and may accordingly leverage processor 302 executing software stored in a memory (e.g., memory 304), or memory 304, or communications hardware 330 for enabling any functions not performed by special-purpose hardware elements. In all embodiments, however, it will be understood that the processor 302, memory 304, entangled photons measurement hardware 310, communications hardware 330, and storage device 370 are implemented via particular machinery designed for performing the functions described herein in connection with such elements of apparatus 300.

In some embodiments, various components of the apparatus 300 may be hosted remotely (e.g., by one or more cloud servers) and thus need not physically reside on the corresponding apparatus 300. Thus, some or all of the functionality described herein may be provided by third party circuitry. For example, a given apparatus 300 may access one or more third party circuitries via any sort of networked connection that facilitates transmission of data and electronic information between the apparatus 300 and the third party circuitries. In turn, that apparatus 300 may be in remote communication with one or more of the other components describe above as comprising the apparatus 300.

As will be appreciated based on this disclosure, example embodiments contemplated herein may be implemented by an apparatus 300. Furthermore, some example embodiments may take the form of a computer program product comprising software instructions stored on at least one non-transitory computer-readable storage medium (e.g., memory 304). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 300 as described in FIGS. 3A-3C, that loading the software instructions onto a computing device or apparatus produces a special-purpose machine comprising the means for implementing various functions described herein.

Turning to FIG. 3B, a diagram of example communications hardware 330 is illustrated. The communications hardware 330 may facilitate communications between apparatus 300 and other devices and reception of one entangled photon of entangled photon pairs from other devices. The communications hardware 330 may include a polarized beam splitter 331, a data coding stage 335, and a measurement basis controller 340. Each of these components is discussed below.

The polarized beam splitter 331 may be any means such as a device (e.g., polarizing plate beam splitters, polarizing beam splitter cubes, prisms, calcite beam displacers, etc.) that is configured to direct optical radiation of different polarizations down different optical paths. For example, the polarized beam splitter may direct vertically polarized optical radiation received from communications network 130 to a first optical path and horizontally polarized optical radiation received from the communications network 130 to a second optical path. The data coding stage 335 may be positioned on the first optical path and the entangled photons measurement hardware 310 may be positioned on the second optical path.

When the optical radiation is impinged on the polarized beam splitter 331, entangled photons may be measured thereby causing the polarization (or other characteristics) of entangled photon pairs to be set (if not previously measured). When the polarization is set, the entangled photons that are vertically polarized may be directed along with optical carriers toward the data coding stage 335. In contrast, horizontally polarized entangled photons may be directed toward the entangled photons measurement hardware 310.

The data coding stage 335 may be any means such as a device that is configured to send data to and receive data from other devices. For example, when services circuitry 306 needs to send data to other devices or receive data from other devices, the data coding stage 335 may encapsulate the data in accordance with a communication scheme and transmit the data over communications network 130 to other devices. The data coding stage 335 may include a data unit processor 336 and an optical transceiver 337. The data unit processor 336 may be a communication protocol compatible communications unit capable of appropriately encapsulating data (e.g., adding headers with control information) and transmitting the encapsulated data across a network to another device. Similarly, the data unit processor 336 may be capable of extracting the payload from encapsulated data received from other devices. The optical transceiver 337 may generate an optical carrier (e.g., vertically polarized optical radiation) and modulate the generated optical carrier to transmit the encapsulated data. Similarly, the optical transceiver 337 may down convert received optical signals to provide encapsulated data to the data unit processor. Generally, the vertically polarized entangled photons received by the optical transceiver 337 may be of such a low power level that they may appear as low level noise to the optical transceiver 337 and not interrupt or reduce its functionality (or that of downstream components such as data unit processor 336).

The measurement basis controller 340 may be any means such as a device that is configured to modify the basis used to measure photons. To appropriately measure entangled photon pairs, information regarding the generation basis may need to be known, as discussed above. The measure basis controller 340 may include, for example, a controller 341 and one or more actuators 342. The actuators 342 may be positioned to modify the positioning and/or orientation of the polarized beam splitter 331 and/or transmission mediums with respect to one another (e.g., to match the measurement angle to a launch angle of optical radiation onto the transmission medium). The actuators 342 may be operably connected to the controller 341 such that the controller 341 may operate the actuators 342 to modify the positioning and/or orientation of the aforementioned components. The controller 341 may be operably connected to the authentication circuitry 308 which may over time modify the measurement basis to correspond to the generation basis for entangled photon pairs. Information regarding these measurement bases may be stored in communication security data repository 374.

Turning to FIG. 3C, a diagram of an example entangled photons measurement hardware 310 is illustrated. As noted above, the entangled photons measurement hardware 310 may facilitate measurement of one entangled photon of each entangled photon pair generated by an initiating device or service. Measuring one of the entangled photons for each of the entangled photon pairs may distribute true random numbers to the apparatus 300 that are identical to those distributed to apparatus 200. When entangled photons are received by the entangled photons measurement hardware 310, the polarization of the photons may be set with the polarized beam splitter or by previous measurement by apparatus 200, but may be unknown to the apparatus 300. To measure entangled photons, the entangled photons measurement hardware 310 may include a measurement stage 311 and a measurement basis controller 315. Each of these components is discussed below.

The measurement stage 311 may be any means such as a device that is configured to measure one entangled photon of entangled photon pairs. The measurement stage 311 may receive the horizontally polarized entangled photons from the communications hardware 330. The measurement stage 311 may include one or more preprocessing devices 312 and a single photon measurement device 313. Photons received by the measurement stage 311 may be impinged on the preprocessing devices 312. The preprocessing devices 312 may perform any optical function (e.g., filtering, polarizing, etc.) in preparation for measurement of the photons. The single photon measurement device 313 may measure photons that impinge on it. The single photon measurement device 313 may be configured to only measure photons from the preprocessing devices 312. For example, single photon measurement device 313 may be shrouded and/or optically coupled to the preprocessing devices 312. Thus, the single photon measurement device 313 may only count horizontally polarized photons by virtue of the polarized beam splitter in the optical path to the measurement device. The single photon measurement device 313 may be implemented using single-photon detectors such as, for example, biased semiconductor junctions, super conducting wires, nanowires, and/or other types of devices.

As discussed above, entangled photons may be generated by the entangled photons generation hardware at a predetermined rate and/or times. The aforementioned rate may be used to determine, for different points in time, the value of bits of a bit sequence corresponding to the different points in time. For example, detection of a photon by the single photon measurement device 313 during a period of time (e.g., when a particular entangled photon would be expected to arrive at the single photon measurement device) may be treated as the value of a bit being a “1” whereas not detecting a photon during the period of time may be treated as the value of the bit being a “0”. Authentication circuitry 308 may be coupled to the single photon measurement device 313 to receive the aforementioned bits to determine the bit sequence corresponding to random numbers known only to apparatuses 200, 300.

The measurement basis controller 315 may be any means such as a device that is configured to modify the basis used to measure photons. To appropriately measure entangled photon pairs, information regarding the generation basis may need to be known. For example, the launch angle along a transmission medium may need to be known to set a corresponding measurement angle from the transmission medium. If not properly set, the photons may not be detectable. The measurement basis controller 315 may include, for example, a controller 316 and one or more actuators 317. The actuators 317 may be positioned to modify the positioning and/or orientation of the preprocessing devices 312 and/or transmission mediums with respect to one another. The actuators 317 may be operably connected to the controller 316 such that the controller 316 may operate the actuators 317 to modify the positioning and/or orientation of the aforementioned components. The controller 316 may be operably connected to the authentication circuitry 208 which may over time modify the measurement basis to correspond to the generation basis for entangled photon pairs.

While apparatuses 200, 300 have been described as including specific types of hardware, it should be appreciated that apparatuses 200, 300 may be capable of providing the functionality of both initiating and receiving devices. Accordingly, an apparatus in accordance with embodiments disclosed herein may include appropriate hardware, discussed above, to provide any of these functionalities. Similarly, a service (e.g., 112, 122) in accordance with embodiments disclosed herein may include the functionalities of both initiating and receiving devices. Accordingly, such services may include hardware similar to that of apparatuses 200, 300 to provide the described functionalities.

Having described specific components of example apparatuses 200 and 300, example embodiments are described below.

### Simultaneous Transmission of Both Data and Entangled Photon Pairs

To facilitate deployment of systems, both data encoded on optical carriers and entangled photons may be simultaneously transmitted using the same transmission medium. Turning to FIG. 4, a diagram of an example deployment is provided that illustrates use of a transmission medium by an initiating device 400 and a participating device 402.

In the deployment, the initiating device 400 is operably connected to a participating device 402 with communications network 130. To facilitate the connection, the communications network 130 includes a transmission medium. The transmission medium may be implemented in various manners. For example, in some embodiments the transmission medium is implemented with fiber optic cables through which optical radiation may be transmitted. The fiber optical cable may support the transmission of both vertically and horizontally polarized optical radiation. In other embodiments, the transmission medium may be free space where optical radiation is propagated without cabling.

To provide for simultaneous transmission of both data and entangled photons, the initiating device 400 may generate an optical carrier with substantially vertically polarized optical radiation. The optical carrier may be modulated and transmitted along the transmission medium to the participating device 402 to communicate data to the participating device.

While the optical carrier is transmitted, the initiating device 400 may also generate entangled photon pairs. The polarization of the entangled photon pairs may be indeterminate when generated. Like the optical carrier, one of the entangled photons from the entangled photon pairs may also be transmitted to the participating device 402 along the transmission medium. In some cases, other optical carriers from other devices may also be present on the transmission medium, along with the optical carrier from the initiating device 400 and the entangled photons. All of the optical carriers may be substantially vertically polarized.

In some embodiments, the transmission medium may be implemented using a mode maintaining fiber (e.g., polarization-maintaining optical fiber) that limits or prevents mode conversion of optical radiation propagating along the transmission medium.

In addition to the transmission medium shown in FIG. 4, the communications network 130 may include other transmission mediums (e.g., other fiber optic cables, electrical cables over which electrical signals may be transmitted, wireless systems such as microwave or optical free space links, etc.) thereby providing for multiple types of operable connections between any number of initiating devices and participating devices.

### Example Apparatus Operations for Authentication of Devices and Users Thereof

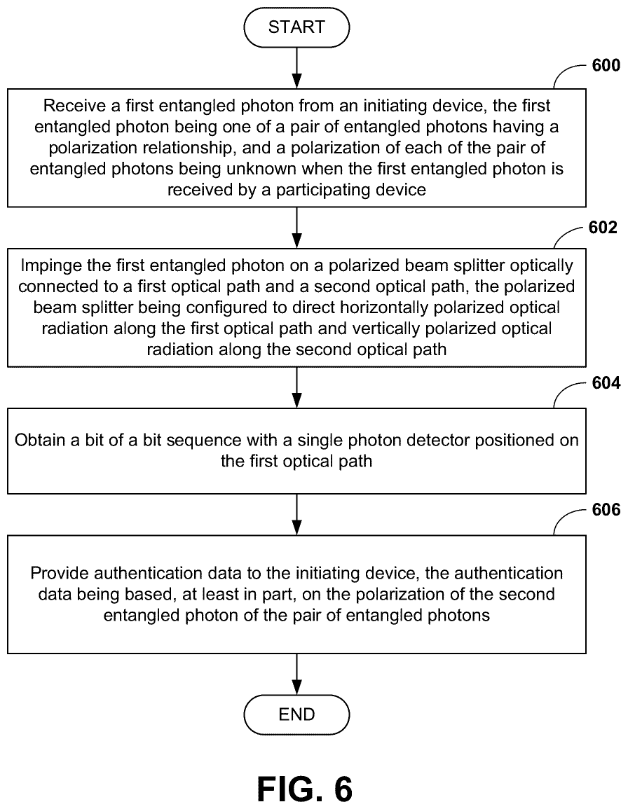

Turning to FIGS. 5-6, example flowcharts are illustrated that contain example operations implemented by various embodiments described herein. FIGS. 5-6 illustrate example operations for authenticating devices and/or users of devices.

The operations illustrated in FIG. 5 may, for example, be performed by initiating devices shown in FIG. 1, which may in turn be embodied by an apparatus 200, which is shown and described in connection with FIGS. 2A-2D. To perform the operations described below, the apparatus 200 may utilize one or more of processor 202, memory 204, services circuitry 206, authentication circuitry 208, entangled photons generation hardware 210, communications hardware 230, entangled photons measurement hardware 250, storage device 270, and/or any combination thereof.

Turning first to FIG. 5, example operations are shown for authenticating a participating device. For example, an initiating device may be performing services that may cause it to distribute sensitive data to a participating device. To reduce the likelihood of the sensitive data being distributed to or intercepted by an unintended recipient, the initiating device may perform an authentication of the participating device (e.g., prior to transmitting the sensitive data). As will be discussed below, the authentication may allow the initiating device to determine whether a presumed identity of the participating device is accurate and to secure communications with the participating device in the future.

As shown by operation 500, the apparatus 200 includes means, such as processor 202, memory 204, authentication circuitry, and entangled photons generation hardware 210, or the like, for generating an entangled photon pair. The pair of entangled photons may have a polarization relationship (or other relationship, e.g., energy level, time, etc.) due to the entanglement. For example, the entanglement relationship may require that each of the entangled photons of the entangled photon pair have a same polarization (e.g., vertical or horizontal) or a different polarization from each other. When the entangled photon pair is generated, the polarizations of the entangled photons of the entangled photon pairs may be unknown and indeterminate by virtue of not being measured.

In one embodiment, the pair of entangled photons is generated by entangled photons generation hardware. For example, the entangled photons generation hardware may generate a laser emission, condition the laser emission, and impinge the laser emission on a non-linear crystal. Impinging the laser emission on the non-linear crystal may initiate spontaneous parametric down-conversion resulting in the generation of the entangled photon pair. By virtue of this generation process, entangled photon pairs may be generated with polarizations corresponding to a true random distribution over time. The entangled photon pairs may be directed along separate optical paths (which are also from a separate optical path of the laser emission).

In one embodiment, the pair of entangled photons is generated by the entangled photons generation hardware when its functionality is invoked by authentication circuitry. For example, the authentication circuitry may monitor and/or identify that services circuitry intends to send (or may in the future send) sensitive data to a device and user thereof. In response to that identification, the authentication circuitry may automatically start performing and/or orchestrating the performance of protective actions. The protective actions may include generation of entangled photon pairs and using the entangled photon pairs to authenticate other devices, users thereof, and/or secure communications with the devices.

In one embodiment, a generation basis for the pair of entangled photons is set prior to the generation. For example, the authentication circuitry may send information to a controller usable to operate actuators to modify the generation basis for the entangled photon pairs. Modifying the generation basis may cause the generated entangled photon pairs to have characteristics that may need to be known to measure the entangled photon pairs. For example, the generation basis may set the polarization relationship between the entangled photon pairs, orient the entangled photon pairs with respect to transmission mediums, etc. The generation basis may be set in accordance with a scheme used to reduce the likelihood of interception of the entangled photon pairs by unintended recipients. For example, the scheme may require rotation or modification of the generation basis over time. The participating device may be aware of the scheme to enable the participating device to appropriately measure the entangled photon pairs.

As shown by operation 502, the apparatus 200 includes means, such as processor 202, memory 204, authentication circuitry, entangled photons generation hardware 210, and communications hardware 230, or the like, for transmitting a first entangled photon of the entangled photon pair to a participating device. The first entangled photon may be transmitted with a transmission medium over which optical radiation is transmitted between the initiating device and the participating device. Generally, a carrier optical signal may be transmitted over the transmission medium along with the first entangled photon. For example, the carrier optical signal may provide for the transmission of data from the initiating device and/or other devices to the participating device. In one embodiment, a polarization of the first entangled photon is unknown and indeterminate while transmitted to the participating device. In other embodiments, the polarization of the first entangled photon is unknown (e.g., not yet measured) but may be determinate by virtue of the polarization of the second entangled photon being measured.

In one embodiment, the first entangled photon is transmitted to the participating device by combining the first entangled photon with an optical carrier on which service data is encoded (which may include sensitive data encrypted with a key). The combination may then be transmitted to the participating device may directing it onto the transmission medium to the participating device. For example, a combiner may be placed along an optical transmission path with both the optical carrier and the first entangled photon (e.g., directed to inputs to the combiner). An output of the combiner may be coupled to the transmission medium thereby launching the combination onto the transmission medium.

As shown by operation 504, the apparatus 200 includes means, such as processor 202, memory 204, authentication circuitry, entangled photons generation hardware 210, entangled photons measurement hardware 250, and storage device 270 or the like, for obtaining a bit of a bit sequence based on a polarization of a second entangled photon of the pair of entangled photon pairs. The bit may be obtained by measuring the polarization of the second entangled photon. The polarization of the second entangled photon may be measured by impinging the second entangled photon on a single photon measurement device. A value of the bit may be obtained by determining whether the single photon measurement device identifies that a photon impinged on it during a predetermined period of time (e.g., when the second entangled photon is expected to reach the single photon measurement device). For example, if the second entangled photon is horizontally polarized, then the single photon measurement device may register an impingement during the predetermined period of time (e.g., corresponding to a value of “1”) whereas in contrast if the second entangled photon is vertically polarized then the single photon measurement device may not register an impingement during the predetermined period of time (e.g., corresponding to a value of “1”). A preprocessing device may screen vertically polarized photons from the measurement device.

When the second entangled photon reaches the single photon measurement device (and/or a pre-processing device in the optical path to the single photon measurement device), the polarization may be determinate (e.g., if the polarization of the first entangled photon has been measured prior to impingement of the second entangled photon) or indeterminate. Consequently, measurement of the second entangled photon may set the polarizations of both entangled photons of the pair of entangled photon pair by virtue of the polarization relationship between the entangled photons.

The value of the bit determined in operation 504 may be stored as part of an entangled photons derived data repository in which a copy of the bit sequence is stored.

The bit sequence obtained may be substantially similar to a corresponding bit sequence obtained by the participating device with the first entangled photon, as will be discussed in greater detail with respect to FIG. 6. Further, due to manner in which the entangled photon pairs are generated, the values of each of the bits of the bit sequence may correspond to a true random distribution.

As shown by operation 506, the apparatus 200 includes means, such as processor 202, memory 204, authentication circuitry 208, and communications hardware 230, or the like, for obtaining authentication data from the participating device. The authentication data may be obtained by receiving it in a communication from the participating device. For example, the authentication circuitry may request that the participating device provide the authentication data. The participating device may send the authentication data to the initiating device in response to the request.

In one embodiment, the authentication data is based on a copy of the bit sequence obtained by the participating device with the first entangled photon. As noted above, both of the initiating device and the participating device may obtain copies of the bit sequence with the entangled photon pairs, and the bits of the bit sequence may correspond to a true random distribution of “1”s and “0”s. The authentication data may be based on a copy of the bit sequence. For example, the authentication data may include a symmetric key generated with a portion of the copy of the bit sequence. The symmetric key may be generated via any method (e.g., with a security function that operates on the portion of the copy of the bit sequence). The authentication may include other types of data based on the bit sequence (e.g., a portion of it, derived data, etc.)

As shown by operation 508, the apparatus 200 includes means, such as processor 202, memory 204, authentication circuitry 208, and storage device 270, or the like, for determining an authentication status of the participating device. The authentication status may be determined with the authentication data and the bit sequence.

For example, the authentication data may be compared to the bit sequence and/or information derived from the bit sequence to determine the authentication status of the participating device. The information derived from the bit sequence may be, for example, a symmetric key, one time use data structure, or other data used by the participating device to generate the authentication data. If the comparison indicates that the authentication data and the bit sequence match (or have other predetermined relationships), then the authentication status may be determined to indicate that the participating device has been authenticated (e.g., that an identity of the participating device, or a user thereof, has been validated).

The authentication status may indicate whether the participating device has an identity presumed by the initiating device. When the initiating device initially contacts the participating device (e.g., at the prompting of the service circuitry), the participating device may provide the initiating device with its alleged identity. Until the alleged identity is validated, the initiating device may treat the alleged identity as being suspect. Accordingly, sensitive data may be withheld from the participating device until the alleged identity is validated with the authentication status.

In one embodiment, the authentication status is used to validate an identity of a user of the participating device. For example, consider a scenario in which an audio communication channel between the initiating device and the participating device has been opened. Through the audio communication channel, the user of the participating device may allege an identity by speaking the identity to a user of the initiating device. However, such communications are subject to forgery and may not be trustworthy. Prior to disclosing sensitive data through the voice communication channel, the authentication circuitry may automatically initiate the operations illustrated in FIG. 5 to authenticate the participating device. Once authenticated, the user of the initiating device may feel free to communicate sensitive data to the user of the participating device.

In one embodiment, the authentication status is used to validate identities of other devices in a computing environment. For example, consider a scenario in which a server in a data center is communicating with other servers in the data center. In such an environment, the server may need to transmit sensitive data to other servers to perform its functionality. To reduce the likelihood of inadvertent transmission of sensitive data to unintended recipients, the server may automatically initiate the operations illustrated in FIG. 5 to authenticate other servers prior to sending copies of the sensitive data to the other servers.

In one embodiment, all or a portion of the bit sequence is used to secure subsequent communications between the initiating device and the participating device after the participating device is authenticated. For example, the initiating device and participating device may only utilize a portion of the bit sequence for authentication. Other portions of the bit sequence may be used to generate (or may be used directly as) symmetric keys. The symmetric keys may be used to encrypt subsequent communications to one another. For example, a data unit processor of communication circuitry may use the symmetric keys to cypher data units to be transmitted between the devices. In such a scenario, when service circuitry generates data to be transmitted to the participating device, the data may be sent to the data unit processor. In turn, the data unit processor may encapsulate and/or otherwise encode the data (e.g., service data) in data units (e.g., packets) compatible with one or more communication protocols (e.g., internet protocol) used by a communication network to transmit the data units. Once generated, the data units and/or payload may be cyphered with the symmetric key. The cyphered data units may then be used to modulate a carrier (e.g., electrical, optical, etc.) to transmit the cyphered data units to the participating device. Once received, the participating device may decrypt the cyphered data units with its copy of the symmetric key. In other examples, portions of the bit sequence may be used as one time pads or cyphering data.

Turning to FIG. 6, example operations are shown for authenticating devices in a distributed system. For example, a participating device may be performing services that may cause it to need to receive sensitive data from an initiating device. To reduce the likelihood of the sensitive data being distributed to or intercepted by an unintended recipient, the initiating device may perform an authentication of the participating device. As part of that process, the participating device may perform actions to facilitate that authentication of the participating device to the initiating device.

The operations illustrated in FIG. 6 may, for example, be performed by participating devices shown in FIG. 1, which may in turn be embodied by an apparatus 300, which is shown and described in connection with FIGS. 3A-3C. To perform the operations described below, the apparatus 200 may utilize one or more of processor 302, memory 304, services circuitry 306, authentication circuitry 308, entangled photons measurement hardware 310, communications hardware 330, storage device 370, and/or any combination thereof.

As shown by operation 600, the apparatus 300 includes means, such as processor 302, memory 304, services circuitry 306, authentication circuitry 308, entangled photons measurement hardware 310, and communications hardware 330, or the like, for receiving a first entangled photon of a pair of entangled photons from an initiating device. The pair of entangled photons may have a polarization relationship (or other relationship, e.g., energy level, time, etc.) due to the entanglement. For example, the entanglement relationship may require that each of the entangled photons of the entangled photon pair have a same polarization (e.g., vertical or horizontal) or a different polarization from each other. When the entangled photon pair is generated, the polarizations of the entangled photons of the entangled photon pairs may be unknown and indeterminate by virtue of not being measured. When the first entangled photon is received by the participating device, the polarization (substantially vertical or substantially horizontal) of the first entangled photon may be unknown to the participating device and/or may be indeterminate (e.g., if neither entangle photon of the entangled photon pair has been measured).

As shown by operation 602, the apparatus 300 includes means, such as processor 302, memory 304, services circuitry 306, authentication circuitry 308, entangled photons measurement hardware 310, and communications hardware 330, or the like, for impinging the first entangled photon on a polarized beam splitter. The polarized beam splitter may be optically connected to a first optical path and a second optical path.

The polarized beam splitter may be configured to direct vertically polarized optical radiation along the first optical path and horizontally polarized optical radiation along the second optical path. For example, the polarized beam splitter may have an input for receiving the first entangled photon (as well as other optical radiation such as a carrier used to transmit data) and two outputs corresponding to the different optical paths.

A data coding stage may be positioned on the first optical path (e.g., to obtain the data transmitted with the optical radiation) and entangled photon measurement hardware may be positioned on the second optical path. By virtue of the positioning, vertically polarized optical radiation (e.g., including the optical carrier and the first entangled photon if it is vertically polarized) received from a transmission medium may be directed to the data coding stage whereas horizontally polarized optical radiation (e.g., only including the first entangled photon if it is horizontally polarized) may be directed to the entangled photon measurement hardware.

Prior to impinging the first entangled photon on the polarized beam splitter, a measurement basis may be set. For example, the authentication circuitry 308 may send instructions to a controller to modify the positioning of the polarized beam splitter and/or other components to match (or be complementary to) a generation basis for the pair of entangled photons.

As shown by operation 604, the apparatus 300 includes means, such as processor 302, memory 304, services circuitry 306, authentication circuitry 308, entangled photons measurement hardware 310, and communications hardware 330, or the like, for obtaining a bit of a bit sequence with a single photon detector positioned on the first optical path. A value of the bit may be obtained by determining whether the single photon measurement device identifies that a photon impinged on it during a predetermined period of time (e.g., when the first entangled photon is expected to reach the single photon measurement device). For example, if the first entangled photon is horizontally polarized, then the single photon measurement device may register an impingement during the predetermined period of time (e.g., corresponding to a value of “1”) whereas in contrast if the first entangled photon is vertically polarized then the single photon measurement device may not register an impingement during the predetermined period of time (e.g., corresponding to a value of “1”) because it may be directed toward the data coding stage rather than to the single photon measurement device.

When the first entangled photon reaches the polarized beam splitter, the polarization may be determinate (e.g., if the polarization of either of the pair of entangled photons has been measured prior to impingement of the first entangled photon) or indeterminate (e.g., if the polarizations of both entangled photons of the pair of entangled photons has not been measured). Consequently, impingement of the first entangled photon may set the polarizations of both entangled photons of the pair of entangled photon pair by virtue of the polarization relationship between the entangled photons.

The value of the bit determined in operation 604 may be stored as part of an entangled photons derived data repository in which a copy of the bit sequence is stored. The bit sequence obtained may be substantially similar to a corresponding bit sequence obtained by an initiating device with a first entangled photon of the pair of entangled photons. Further, due to manner in which entangled photon pairs are generated, the values of each of the bits of the bit sequence may correspond to a true random distribution.

As shown by operation 606, the apparatus 300 includes means, such as processor 302, memory 304, authentication circuitry 308, and communications hardware 330, or the like, for providing authentication data to an initiating device. The authentication data may be provided by generating it with all, or a portion, of the bit sequence. Once generated, the authentication data may be transmitted to the initiating device.

In one embodiment, the authentication data is based on a copy of the bit sequence obtained by the participating device. The authentication data may include portions of the bit sequence and/or information obtain with the bit sequence. For example, a security function may be used to generate a symmetric key, which may be used as the authentication data.

If the initiating device determines that the participating device has been authenticated, the two device may begin to communicate with one another using secure communications. For example, the bit sequence may be used to obtain keys for cyphering data transmitted between the devices thereby establishing a secure communications channel. If the initiating device authenticates the participating device, then the initiating device may send the sensitive data to the participating device. In this manner, the secure communications channel may be established without needing to communicate with other devices (e.g., a key service such as devices that publish public keys for other devices) or to use other information (e.g., such as public keys) from other devices.

For example, the participating device may receive an optical carrier having data encoded on it with the cypher. The optical carrier may consist essentially of vertically polarized optical radiation. Consequently, when it is impinged on the polarized beam splitter it may be directed along the first optical path to the data coding sage. The data coding stage then use the symmetric key to obtain the data from the carrier. Additionally, during this process, other entangled photons may continue to be impinged on the polarized beam splitter, along with the optical carrier, so that the participating device and initiating device may continue to obtain bits of the bit sequence. The only difference between these optical signals may be the polarization. In contrast, the entangled photons and the optical carrier may have substantially overlapping spectral content (e.g., may exist in substantially similar frequency bands) and temporal content.

As described above, example embodiments provide methods and apparatuses that enable improved device and user authentication in a distributed environment. The example embodiments provide tools that overcome the problems faced by actors in a distributed environment where the identities of the actors are not immediately discernable or may be forged by various actors. By authenticating the devices and users thereof in advance of distributing sensitive data, undesired distribution of the sensitive data to unintended recipients may be avoided.

FIGS. 5-6 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations above may be modified or further amplified. Furthermore, in some embodiments, additional optional operations may be included. Modifications, amplifications, or additions to the operations above may be performed in any order and in any combination.

### Example System Operations

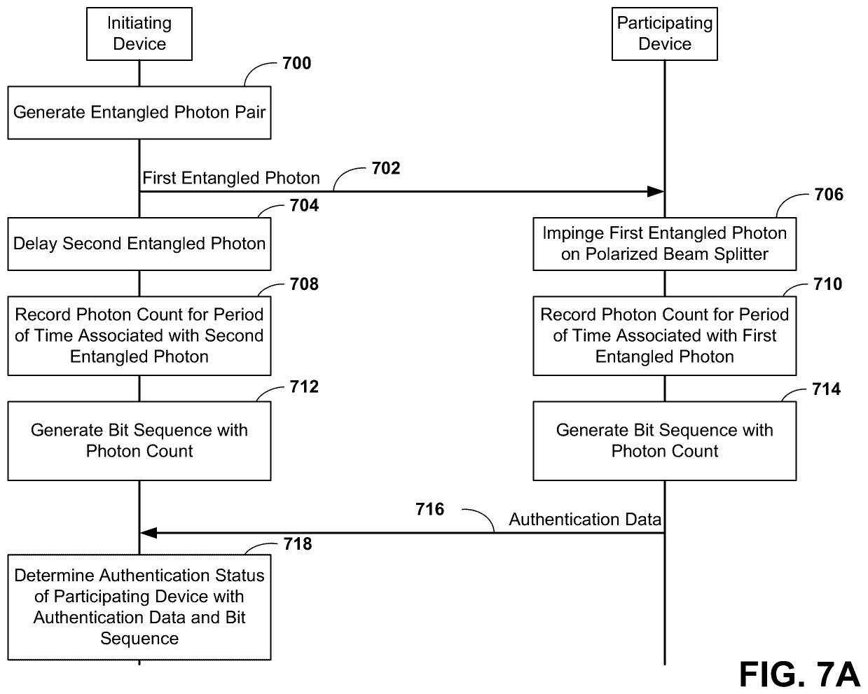

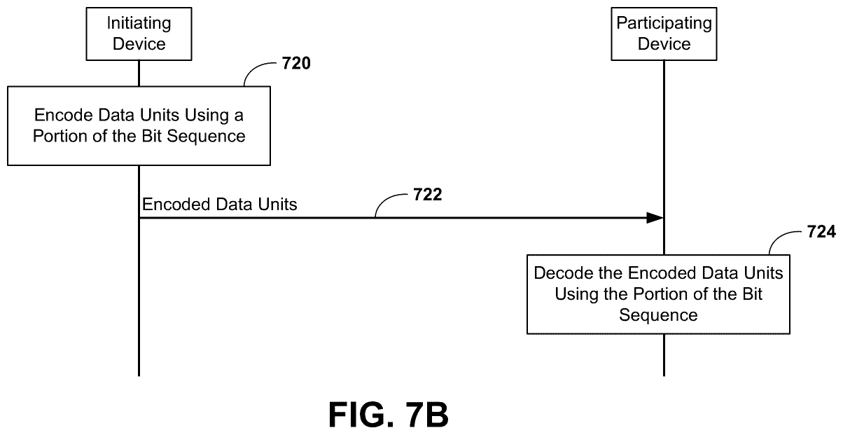

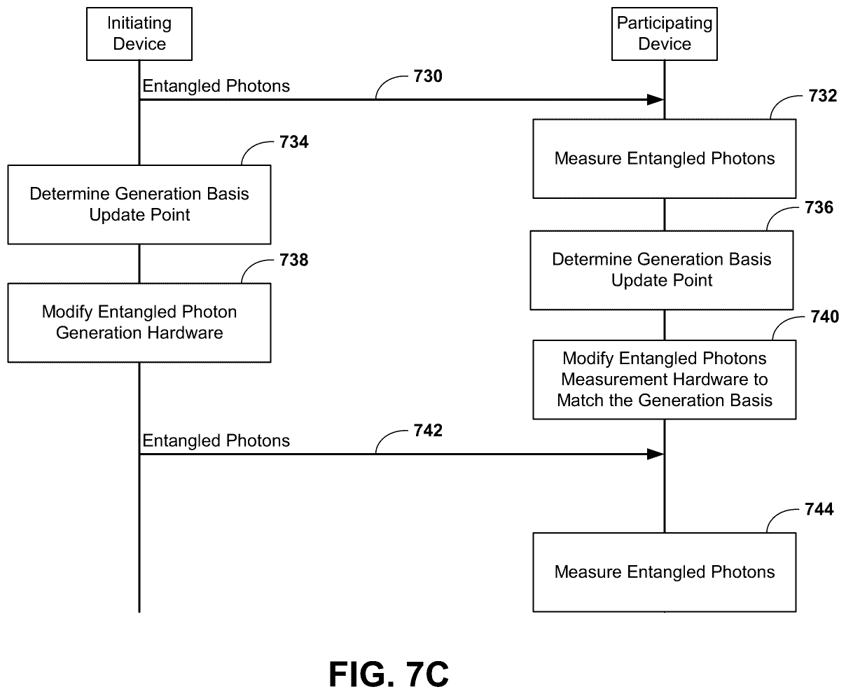

As noted above, initiating devices and participating devices may facilitate authentication of devices in a distributed system. FIGS. 7A-7C show diagrams illustrating example operations performed by components of a distributed system that may be performed when authenticating a device. In these figures, operations performed by an initiating device are shown along the line extending from the box labeled “initiating device.” Similarly, operations performed by a participating device are shown along the line extending from the box labeled “participating device.” Operations impacting both devices, such as data transmissions between the devices, are shown using arrows extending between these lines. Generally, the operations are ordered temporally with respect to one another. However, it will be appreciated that the operations may be performed in other orders from those illustrated herein.

Turning first to FIG. 7A, at operation 700, an initiating device generates an entangled photon pair. The initiating device may do so when it anticipates sending sensitive data to the participating device. For example, the initiating device may be providing VOIP services, general data distribution services, and/or other types of services to the participating device may result in the distribution of sensitive data to the participating device.

When generated, the entangled photon pair may be in an indeterminate state. At operation 702, the initiating device transmits a first entangled photon of the entangled photon pair to the participating device. The first entangled photon may be transmitted to the participating device with an optical fiber, or other transmission medium, used by the initiating device and/or other devices to transmit data to the participating device with an optical carrier that is substantially vertically polarized. At operation 704, the initiating device may delay a second entangled photon of the second entangled photon pair. The delay may be such that the entangled photon pair stays in an indeterminate state while the first entangled photon travels to the participating device, or for another duration of time.

At operation 706, the participating device impinges the first entangled photon on a polarized beam splitter. Doing so may place the entangled photon pair into a determinate state (if neither of the entangled photons have been previously measured which would have already placed both photons in a determinate state). Additionally, the optical carrier may also be impinged on the polarized beam splitter. The beam splitter may direct vertically polarized optical radiation (including the optical carrier and which may or may not include the first entangled photon) towards a data coding stage and horizontally polarized optical radiation (which does not include the optical carrier and which may or may not include the first entangled photon) to a single photon measurement device. Consequently, the first entangled photon may only reach the single photon measurement device if it is horizontally polarized. By virtue of the method used to generate the entangled photon pair, the first entangled photon may have a vertical or horizontal polarization.

At operations 708 and 710, the initiating device and participating device, respectively, record a photon count using single photon detection devices during the time periods during which the first and second entangled photons should arrive at the respective single photon detection devices (presuming that the entangled photon pairs are horizontally polarized). If a photon is counted during the aforementioned time periods, then at operations 712 and 714 the initiating device and participating device may record a “1” to generate copies of a bit sequence maintained by the respective devices. In contrast, if no photons are counted during these time periods, then at operations 712 and 714 the initiating device and participating device may record a “0” to generate copies of a bit sequence maintained by the respective devices. By virtue of the entanglement of the entangled photon pair, both single photon detection devices will either detect or not detect a photon during these time periods.

Operations 700-714 may be repeated any number of times to generate a bit sequence of any length.

At operation 716, the participating device generates and sends authentication data to the initiating device. The authentication may be based on the copy of the bit sequence maintained by the participating device.

At operation 718, the initiating device determines the authentication status of the participating device with the authentication data and the copy of the bit sequence maintained by the initiating device. To do so, the initiating device may perform a comparison (or other operation) between the authentication data and the bit sequence to determine whether the participating device has a copy of the bit sequence. If the initiating device determines that the participating device has a copy of the bit sequence, then the initiating device determines that the participating device is authenticated (e.g., has an authenticated status).

If the initiating device determines that the participating device is authenticated, then the initiating device may begin to transmit sensitive data to the participating device. FIG. 7B shows operations that may be performed to transmit sensitive data.

Turning first to FIG. 7B, at operation 720, data units are encoded using a portion of the bit sequence. By virtue of the generation method of the entangled photon pairs used to generate the bit sequence, the values of the bits of the bit sequence may be a true random distribution. The data units may be encoded by cyphering the payload with the portion of the bit sequence, with symmetric keys derived from the portion of the bit sequence, with one time pads derived from the portion of the bit sequence, or other cryptographic instruments derived from the portion of the bit sequence and/or other information.

At operation 722, the initiating device transmits the encoded data units to a participating device. The encoded data units may be transmitted with an optical carrier over the same transmission medium used to distribute the first entangled photon to the participating device.

At operation 724, the participating device decodes the encoded data units using the portion of the bit sequence. The data units may be decoded by deciphering the payload with the portion of the bit sequence, with symmetric keys derived from the portion of the bit sequence, with one time pads derived from the portion of the bit sequence, or other cryptographic instruments derived from the portion of the bit sequence and/or other information.

During the processes illustrated in FIGS. 7A and 7B as well as afterward, entangled photon pairs may be generated and transmitted to distribute true random bit sequences to the initiating device and participating device. During these processes, the generation basis for the entangled photon pairs may be changed. The corresponding measurement process may also be updated to match the generation process. The operation flow shown in FIG. 7C may be performed at any time and repetitively to reduce the likelihood that a third party may be able to interfere with the distribution of the bit sequences to these devices.

At operation 730, entangled photons are transmitted from the initiating device to the participating device. The entangled photons may include a one photon from multiple pairs of entangled photons to facilitate distribution of the bit sequences to the initiating device and participating device. These entangled photons may all be generated with a same first basis.

At operation 732, the participating device measures the entangled photons. The participating device may measure the entangled photons with a first measurement basis that is based on the first generation basis. For example, the participating device may utilize a same angle for receiving the entangled photons from a transmission medium with which the initiating device used to launch the entangled photons onto the transmission medium. In another example, the participating device may measure a similar property (e.g., polarization) with which the initiating device will also measure when determining the values of the bit sequence.

At operation 734, the initiating device determines that a generation basis update point has occurred. The generation basis update point may be, for example, a predetermined point in time. The initiating device and participating device may utilize a schedule or other vehicle for ascertaining when generation basis update points occur.

At operation 736, the participating device also determines that a generation basis update point has occurred.

At operation 738, the initiating device modifies the entangled photon generation hardware to update the generation basis.

At operation 740, the participating device similarly updates its entangled photons measurement hardware to match the generation basis. The initiating device and participating device may make the aforementioned modifications in accordance with a schedule, at pattern defined by the bit pattern, and/or via other methods to allow both devices to be able to determine the generation basis, and changes thereof, over time.

At operation 742, the initiating device resumes generation and transmission of entangled photons to the participating device. However, the generation basis of these entangled photons may be updated thereby making it more difficult for others that do not have access to the generation basis to gain access to the bit sequence (e.g., by intercepting the entangled photons).

At operation 744, the participating device measures the entangled photons. The participating device may measure the entangled photons with the updated measurement basis that is based on the updated generation basis.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for authentication between an initiating device and a participating device operably connected to each other with a transmission medium used to transmit data between the initiating device and the participating device, the method comprising:
performing, by the initiating device, at least two iterations of a photon distribution process, the photon distribution process comprising:
generating, by generation hardware of the initiating device, a pair of entangled photons, the pair of entangled photons having a polarization relationship, and a polarization of each entangled photon of the pair of entangled photons being unknown when generated, and
transmitting, by communication hardware of the initiating device and via the transmission medium, one entangled photon of the pair of entangled photons to the participating device;
obtaining, by measurement hardware of the initiating device and after performing the at least two iterations of the photon distribution process, a bit sequence based at least on a polarization of a second entangled photon of a first pair of entangled photons generated via the at least two iterations of the photon distribution process and a polarization of a third photon, the third photon being from a second pair of entangled photons generated via the at least two iterations of the photon distribution process, the polarization relationship fixing the polarizations of the first pair of entangled photons and the second pair of entangled photons upon a first polarization measurement of either photon of the first pair of entangled photons or the second pair of entangled photons;
obtaining, by the communication hardware, authentication data from the participating device, the authentication data being based, at least in part, on the polarization of a first entangled photon of the first pair of entangled photons; and
determining, by authentication circuitry of the initiating device, an authentication status of the participating device based on a comparison of the authentication data and the bit sequence.

2. The method of claim 1, further comprising:
encoding, by the communication hardware, data using the bit sequence; and
transmitting, by the communication hardware, the encoded data to the participating device with the transmission medium.

3. The method of claim 2, wherein transmitting the encoded data comprises:
generating, by the communication hardware, a vertically polarized optical carrier transmitted to the participating device with the transmission medium; and
modulating, by the communication hardware, the vertically polarized optical carrier to communicate the encoded data to the participating device.

4. The method of claim 2, wherein the authentication data obtained from the participating device is encoded, and wherein the method further comprises:
obtaining, by the authentication circuitry, a key based on a portion of the bit sequence; and
decoding, by the authentication circuitry, the authentication data using the key.

5. The method of claim 4, wherein the data is encoded using the bit sequence using the key as a symmetric key for the encoded data.

6. The method of claim 1, wherein obtaining the bi-t-ef-the-bit sequence comprises:
maintaining, by the measurement hardware, entanglement of the first pair of entangled photons until the polarization of an entangled photon of the first pair of entangled photons is measured; and
measuring, by a single photon detector of the measurement hardware, the second entangled photon of the first pair of entangled photons to obtain a value of a bit of the bit sequence.

7. The method of claim 6, wherein measuring the second entangled photon of the first pair of entangled photons comprises:
determining, by the single photon detector, a received photon count during a predetermined period of time associated with the second entangled photon of the first pair of entangled photons;
determining, by authentication circuitry of the initiating device, that the value of the bit of the bit sequence is zero when the received photon count indicates that no photons were received during the period of time; and
determining, by the authentication circuitry, that the value of the bit of the bit sequence is one when the received photon count when the received photon count indicates that at least one photon was received during the period of time.

8. The method of claim 1, wherein generating the pair of entangled photons comprises:
setting, by an actuator of the generation hardware, a generation basis for the pair of entangled photons, the polarization relationship being based on the generation basis; and
after setting the generation basis, initiating, by a laser source and a nonlinear optical crystal of the generation hardware, spontaneous parametric down-conversion to obtain the pair of entangled photons.

9. The method of claim 8, wherein the generation basis is modified by the generation hardware over time in accordance with a predetermined pattern known to the participating device.

10. The method of claim 9, wherein obtaining the bit sequence comprises:
determining the polarization relationship based on the generation basis; and
measuring, by a single photon detector of the measurement hardware, the second entangled photon of the first pair of entangled photons based on the polarization relationship to obtain a value of a bit of the bit sequence.

11. An initiating device for secure distribution of data to a participating device via a transmission medium, the initiating device comprising hardware configured to perform at least two iterations of a photon distribution process, the hardware comprising:
generation hardware configured to generate a pair of entangled photons, the pair of entangled photons having a polarization relationship, and a polarization of each entangled photon of the pair of entangled photons being unknown when generated, and
communication hardware configured to transmit one entangled photon of the pair of entangled photons to the participating device via the transmission medium;
wherein the initiating device further comprises:
measurement hardware configured to obtain, after performing the at least two iterations of the photon distribution process, a bit sequence based at least on a polarization of a second entangled photon of a first pair of entangled photons generated via the at least two iterations of the photon distribution process and a polarization of a third photon, the third photon being from a second pair of entangled photons generated via the at least two iterations of the photon distribution process, the polarization relationship fixing the polarizations of the first pair of entangled photons upon a first polarization measurement of either photon of the first pair of entangled photons or the second pair of entangled photons;
wherein the communication hardware is further configured to obtain authentication data from the participating device, the authentication data being based, at least in part, on the polarization of a first entangled photon of the first pair of entangled photons,
wherein the initiating device further comprises authentication circuitry configured to determine an authentication status of the participating device based on a comparison of the authentication data and the bit sequence.

12. The initiating device of claim 11, wherein the communication hardware is further configured to:
encode data using the bit sequence; and
transmit the encoded data to the participating device with the transmission medium.

13. The initiating device of claim 12, wherein the encoded data is transmitted by:
generating a vertically polarized optical carrier transmitted to the participating device with the transmission medium; and
modulating the vertically polarized optical carrier to communicate the encoded data to the participating device.

14. The initiating device of claim 12, wherein the authentication data obtained from the participating device is encoded, and wherein the authentication circuitry is further configured to:
obtain a key based on a portion of the bit sequence; and
decode the authentication data using the key.

15. The initiating device of claim 14, the data is encoded using the bit sequence using the key as a symmetric key for the encoded data.

16. The initiating device of claim 11, wherein the bit sequence is obtained by:
maintaining entanglement of the first pair of entangled photons until the polarization of an entangled photon of the first pair of entangled photons is measured; and
measuring the second entangled photon of the pair of entangled photons to obtain a value of a bit of the bit sequence.

17. The initiating device of claim 16, wherein the second entangled photon of the first pair of entangled photons is measured by:
determining a received photon count during a predetermined period of time associated with the second entangled photon of the first pair of entangled photons;
determining that the value of the bit of the bit sequence is zero when the received photon count indicates that no photons were received during the period of time; and
determining that the value of the bit of the bit sequence is one when the received photon count when the received photon count indicates that at least one photon was received during the period of time.

18. The initiating device of claim 11, wherein the pair of entangled photons is generated by:
setting a generation basis for the pair of entangled photons, the polarization relationship being based on the generation basis; and
after setting the generation basis, initiating spontaneous parametric down-conversion to obtain the pair of entangled photons.

19. The initiating device of claim 18, wherein the generation hardware is further configured to modify the generation basis over time in accordance with a predetermined pattern known to the participating device.

20. An initiating device for secure distribution of data to a participating device via a transmission medium, the initiating device comprising:
means for performing at least two iterations of a photon distribution process, the means comprising:
a first means for generating a pair of entangled photons, the pair of entangled photons having a polarization relationship, and a polarization of each entangled photon of the pair of entangled photons being unknown when generated; and
a second means for transmitting one entangled photon of the pair of entangled photons to the participating device via the transmission medium;
wherein the initiating device further comprises:
a third means for obtaining, after performing the at least two iterations of the photon distribution process a bit sequence based at least on a polarization of a second entangled photon of the pair of entangled photons generated via the at least two iterations of the photon distribution process and a polarization of a third photon, the third photon being from a second pair of entangled photons generated via the at least two iterations of the photon distribution process, the polarization relationship fixing the polarizations of the first pair of entangled photons and the second pair of entangled photons upon a first polarization measurement of either photon of the first pair of entangled photons or the second pair of entangled photons;
wherein the second means further comprises means for obtaining authentication data from the participating device, the authentication data being based, at least in part, on the polarization of a first entangled photon of the pair of entangled photons,
wherein the initiating device further comprises fourth means for determining an authentication status of the participating device based on a comparison of the authentication data and the bit sequence.

21-40. (canceled)
